(19) United States
(12) Patent Application Publication
(10) Pub. No.: US 2025/0350898 A1
(43) Pub. Date: Nov. 13, 2025

(54) Object-based Audio Spatializer With Crosstalk Equalization

(71) Applicant: Nintendo Co., Ltd., Kyoto (JP)

(72) Inventor: Jeff THOMPSON, Sammamish, WA (US)

(21) Appl. No.: 19/275,954

(22) Filed: Jul. 21, 2025

Related U.S. Application Data
(63) Continuation-in-part of application No. 18/424,295, filed on Jan. 26, 2024, now Pat. No. 12,395,806.
Application No. 18/424,295 is a continuation of application No. 17/513,249, filed on Oct. 28, 2021, now Pat. No. 11,924,623.
(60) Provisional application No. 63/781,932, filed on Apr. 1, 2025.

(51) Int. Cl. H04S 7/00; A63F 13/54; A63F 13/814

(52) U.S. Cl. CPC H04S 7/30; A63F 13/54; A63F 13/814; H04S 2400/01; H04S 2420/01

(57) ABSTRACT

A 3D sound spatializer provides delay-compensated HRTF interpolation techniques, efficient cross-fading between current and delayed HRTF filter results, and per-object equalization and stabilization, to mitigate artifacts caused by interpolation between HRTF filters, the use of time-varying HRTF filters, and spectral coloration due to loudspeaker playback including acoustic crosstalk.

### CROSS-REFERENCE TO RELATED APPLICATIONS

This application is a continuation-in-part of U.S. patent application Ser. No. 18/424,295, filed Jan. 26, 2024, now U.S. Pat. No. ______, which is a continuation of U.S. patent application Ser. No. 17/513,249, filed Oct. 28, 2021, now U.S. Pat. No. 11,924,623. This application also claims benefit of U.S. Provisional Patent Application No. 63/781,932, filed Apr. 1, 2025. This application is related to U.S. application Ser. No. 17/513,175, filed Oct. 28, 2021, now U.S. Pat. No. 11,665,498. These applications are incorporated herein by reference in their entirety and for all purposes.

### FIELD

The technology herein relates to 3D audio, and more particularly to signal processing techniques for improving the quality and accuracy of virtual 3D object placement in a virtual sound generating system for augmented reality, video games and other applications.

### BACKGROUND

Even though we only have two ears, we humans are able to detect with remarkable precision the 3D position of sources of sounds we hear. Sitting on the back porch on a summer night, we can hear cricket sounds from the left, frog sounds from the right, the sound of children playing behind us, and distant thunder from far away in the sky beyond the horizon. In a concert hall, we can close our eyes and hear that the violins are on the left, the cellos and double basses are on the right with the basses behind the cellos, the winds and violas are in the middle with the woodwinds in front, the brasses in back and the percussion behind them.

Some think we developed such sound localization abilities because it was important to our survival—perceiving a sabre tooth tiger rustling in the grass to our right some distance away but coming toward us allowed us to defend ourselves from attack. Irrespective of how and why we developed this remarkable ability to perceive sound localization, it is part of the way we perceive the world. Therefore, when simulating reality with a virtual simulation such as a video game (including first person or other immersive type games), augmented reality, virtual reality, enhanced reality, or other presentations that involve virtual soundscapes and/or 3D spatial sound, it has become desirable to model and simulate sound sources so we perceive them as having realistic spatial locations in three dimensional space.

### Lateral Localization

It is intuitive that sounds we hear mostly with our left ear are coming from our left, and sounds we hear mostly with our right ear are coming from our right. A simple stereo pan control uses variable loudness levels in left and right headphone speakers to create the illusion that a sound is towards the left, towards the right, or in the center.

The psychoacoustic mechanisms we use for detecting lateral or azimuthal localization are actually much more complicated than simple stereo intensity panning. Our brains are capable of discerning fine differences in both the amplitude and the timing (phase) of sounds detected by our ears. The relative delay between the time a sound arrives at our left ear versus the time the same sound arrives at our right ear is called the interaural time difference or ITD. The difference in amplitude or level between a sound detected by our left ear versus the same sound detected by our right ear is called the interaural level difference or ILD. Our brains use both ILD and ITD for sound localization.

It turns out that one or the other (ILD or ITD) is more useful depending on the characteristics of a particular sound. For example, because low frequency (low pitched) sounds have wavelengths that are greater than the dimensions of our heads, our brains are able to use phase (timing difference) information to detect lateral direction of low frequency or deeper pitched sounds. Higher frequency (higher pitched) sounds on the other hand have shorter wavelengths, so phase information is not useful for localizing sound. But because our heads attenuate higher frequency sounds more readily, our brains use this additional information to determine the lateral location of high frequency sound sources. In particular, our heads “shadow” from our right ear those high frequency sounds originating from the left side of our head, and “shadow” from our left ear those high frequency sounds originating from the right side of our head. Our brains are able to detect the minute differences in amplitude/level between our left and right ears based on such shadowing to localize high frequency sounds. For middle frequency sounds there is a transition region where both phase (timing) and amplitude/level differences are used by our brains to help us localize the sound.

### Elevation and Front-to-Back Localization

Discerning whether a sound is coming from behind us or in front of us is more difficult. Think of a sound source directly in front of us, and the same sound directly behind us. The sounds the sound source emanates will reach our left and right ears at exactly the same time in either case. Is the sound in front of us, or is it behind us? To resolve this ambiguity, our brains rely on how our ears, heads and bodies modify the spectra of sounds. Sounds originating from different directions interact with the geometry of our bodies differently. Sound reflections caused by the shape and size of our head, neck, shoulders, torso, and especially, by the outer ears (or pinnae) act as filters that modify the frequency spectrum of the sound that reaches our eardrums.

Our brains use these spectral modifications to infer the direction of the sound's origin. For example, sounds approaching from the front produce resonances created by the interior complex folds of our pinnae, while sounds from the back are shadowed by our pinnae. Similarly, sounds from above may reflect off our shoulders, while sounds from below are shadowed by our torso and shoulders. These reflections and shadowing effects combine to allow our brains to apply what is effectively a direction-selective filter.

### Audio Spatialization Systems

Since the way our heads modify sounds is key to the way our brains perceive the direction of the sounds, modern 3D audio systems attempt to model these psychoacoustic mechanisms with head-related transfer functions (HRTFs). A HRTF captures the timing, level, and spectral differences that our brains use to localize sound and is the cornerstone of most modern 3D sound spatialization techniques.

A HRTF is the Fourier transform of the corresponding head-related impulse response (HRIR). Binaural stereo channels y_{L}(t) and y_{R}(t) are created (see FIG. 5) by convolving a mono object sound x(t) with a HRIR for each ear h_{L}(t) and h_{R}(t). This process is performed for each of the M sound objects (FIG. 5 shows three different sound objects but there can be any number M), each sound object representing or modeling a different sound source in three-dimensional virtual space. Equivalently, the convolution can be performed in the frequency-domain by multiplying a mono object sound X(f) with each HRTF H_{L}(f) and H_{R}(f), i.e.,

$${Y}_{L} ( f ) = X ( f ) {H}_{L} ( f )$$

$${Y}_{R} ( f ) = X ( f ) {H}_{R} ( f )$$

The binaural method, which is a common type of 3D audio effect technology that typically employs headphones worn by the listener, uses the HRTF of sounds from the sound sources to both ears of a listener, thereby causing the listener to recognize the directions from which the sounds apparently come and the distances from the sound sources. By applying different HRTFs for the left and right ear sounds in the signal or digital domain, it is possible to fool the brain into believing the sounds are coming from real sound sources at actual 3D positions in real 3D space.

For example, using such a system, the sound pressure levels (gains) of sounds a listener hears change in accordance with frequency until the sounds reach the listener's eardrums. In 3D audio systems, these frequency characteristics are typically processed electronically using a HRTF that takes into account not only direct sounds coming directly to the eardrums of the listener, but also the influences of sounds diffracted and reflected by the auricles or pinnae, other parts of the head, and other body parts of the listener—just as real sounds propagating through the air would be.

The frequency characteristics also vary depending on source locations (e.g., the azimuth orientations). Further, the frequency characteristics of sounds to be detected by the left and right ears may be different. In spatial sound systems, the frequency characteristics of, sound volumes of, and time differences between, the sounds to reach the left and right eardrums of the listener are carefully controlled, whereby it is possible to control the locations (e.g., the azimuth orientations) of the sound sources to be perceived by the listener. This enables a sound designer to precisely position sound sources in a soundscape, creating the illusion of realistic 3D sound. See for example U.S. Pat. No. 10,796,540B2; Sodnik et al., “Spatial sound localization in an augmented reality environment”, OZCHI '06: Proceedings of the 18th Australia conference on Computer-Human Interaction: Design: Activities, Artefacts and Environments (November 2006) Pages 111-118https://doi.org/10.1145/1228175.1228197; Immersive Sound: The Art and Science of Binaural and Multi-Channel Audio (Routledge 2017).

While much work has been done in the past, further improvements are possible and desirable.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block schematic diagram of an example sound capture system.

FIG. 1A is a flowchart of example program control steps performed by the FIG. 1 system.

FIG. 2 is a block diagram of an example sound and graphics generating system.

FIG. 3 is a block diagram of an example sound generating system portion of the FIG. 2 system.

FIG. 4 is a flowchart of example program control steps performed by the FIG. 2 system.

FIG. 5 shows example spatialization parameters.

FIG. 6 is a block diagram of an example object-based spatializer architecture that can be incorporated into the systems of FIGS. 2 and 3.

FIG. 7 shows an example spatialization interpolation region.

FIG. 8 illustrates desired time-alignment between HRTF filters.

FIG. 9 shows an example block diagram of an example delay-compensated bilinear interpolation technique.

FIG. 10 is a block diagram of an example modified architecture that uses cross-fading.

FIG. 11 shows frame time windows.

FIG. 12 shows frame time windows with cross-fade.

FIGS. 13A and 13B show frequency domain comparisons, with FIG. 13A showing a frequency domain spectrogram without delay compensation and FIG. 13B showing a frequency domain spectrogram with delay compensation.

FIGS. 14A and 14B show a time domain comparison, with FIG. 14A showing a time domain plot without delay compensation and FIG. 14B showing a time domain plot with delay compensation.

FIG. 15 shows example cross-talk paths.

FIG. 16 shows example cross-talk paths in a spatializer context.

FIG. 16A is a flowchart of example automated program control steps that may be performed by a programmed digital signal processor and/or an appropriately structured digital signal processing circuit in example embodiments.

FIG. 17 shows example cross-talk paths to a listener's respective ears from internal left and right loudspeakers of a handheld stereophonic (multi-channel) video game playing device.

### DETAILED DESCRIPTION OF NON-LIMITING EMBODIMENTS

A new object-based spatializer algorithm and associated sound processing system has been developed to demonstrate a new spatial audio solution for virtual reality, video games, and other 3D audio spatialization applications. The spatializer algorithm processes audio objects to provide a convincing impression of virtual sound objects emitted from arbitrary positions in 3D space when listening over headphones or in other ways.

The object-based spatializer applies head-related transfer functions (HRTFs) to each audio object, and then combines all filtered signals into a binaural stereo signal that is suitable for headphone or other playback. With a high-quality HRTF database and novel signal processing, a compelling audio playback experience can be achieved that provides a strong sense of externalization and accurate object localization.

### Example Features

The following are at least some exemplary features of the object-based spatializer design:
Spatializes each audio object independently based on object position
Supports multiple (M) simultaneous objects
Object position can change over time
Reasonable CPU load (e.g., through the use of efficient FFT-based convolution or other techniques)
Novel delay-compensated HRTF interpolation technique
Efficient cross-fading technique to mitigate artifacts caused by time-varying HRTF filters

Example embodiments herein further include a cross-talk reducing technique comprising:
1. Determining HRTFs based on object position
A. Table lookup or interpolation
B. Assumes headphone playback, i.e., reproduction with no crosstalk
2. Modifying HRTFs for loudspeaker playback
A. Uses original HRTFs and known loudspeaker transfer functions
B. Solves a linear system model
3. Calculating and applying equalization
A. Uses nonlinear energy-based analysis that seems to match human perception better than the linear system solution in step 2, particularly at higher frequencies

Example embodiments thus re-analyze and modify the results of a linearly-derived solution using nonlinear analysis. Since nonlinear systems tend to be difficult to solve, it's not at all trivial to directly formulate and solve a nonlinear system. Furthermore, operating per-object is helpful because in nonlinear systems superposition doesn't hold, so the same results would not be achieved by operating on the output of multiple objects.

### Example Sound Capture System

The object-based spatializer can be used in a video game system, artificial reality system (such as, for example, an augmented or virtual reality system), or other system with or without a graphics or image based component, to provide a realistic soundscape comprising any number M of sound objects. The soundscape can be defined in a three-dimensional (xyz) coordinate system. Each of plural (M) artificial sound objects can be defined within the soundscape. For example, in a forest soundscape, a bird sound object high up in a tree may be defined at one xyz position (e.g., as a point source), a waterfall sound object could be defined at another xyz position or range of positions (e.g., as an area source), and the wind blowing through the trees could be defined as a sound object at another xyz position or range of positions (e.g., another area source). Each of these objects may be modeled separately. For example, the bird object could be modeled by capturing the song of a real bird, defining the xyz virtual position of the bird object in the soundscape, and (in advance or during real time playback) processing the captured sounds through a HRTF based on the virtual position of the bird object and the position (and in some cases the orientation) of the listener's head. Similarly, the sound of the waterfall object could be captured from a real waterfall, or it could be synthesized in the studio. The waterfall object could be modeled by defining the xyz virtual position of the waterfall object in the soundscape (which might be a point source or an area source depending on how far away the waterfall object is from the listener). And (in advance or during real time playback) processing the captured sounds through a HRTF based on the virtual position of the waterfall and the position (and in some cases the orientation) of the listener's head. Any number M of such sound objects can be defined in the soundscape.

At least some of the sound objects can have a changeable or dynamic position (e.g., the bird could be modeled to fly from one tree to another). In a video game or virtual reality, the positions of the sound objects can correspond to positions of virtual (e.g., visual or hidden) objects in a 3D graphics world so that the bird for example could be modeled by both a graphics object and a sound object at the same apparent virtual location relative to the listener. In other applications, no graphics component need be present.

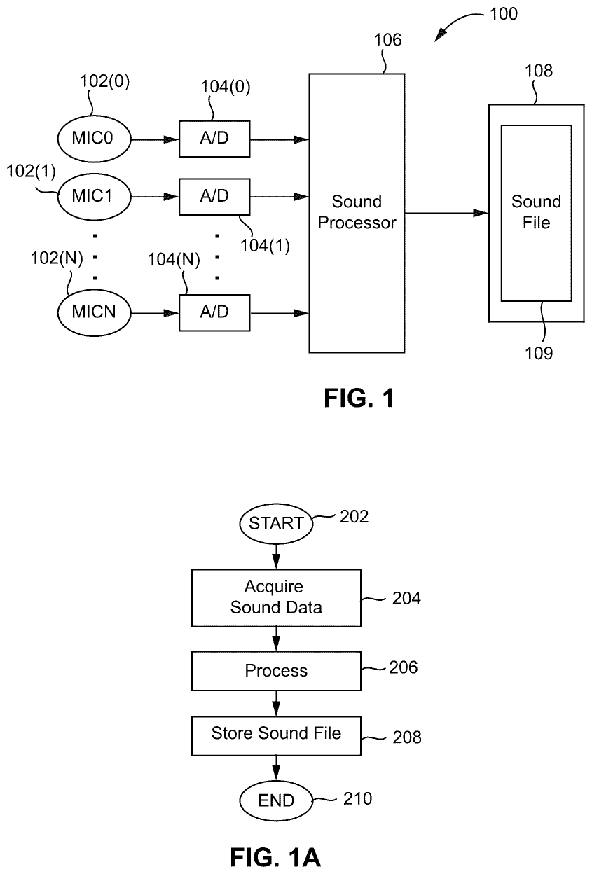

To model a sound object, the sound of the sound source (e.g., bird song, waterfall splashes, blowing wind, etc.) is first captured from a real world sound or artificial synthesized sound. In some instances, a real world sound can be digitally modified, e.g., to apply various effects (such as making a voice seem higher or lower), remove unwanted noise, etc. FIG. 1 shows an example system 100 used to capture sounds for playback. In this example, any number of actual and/or virtual microphones 102 are used to capture a sound (FIG. 1A blocks 202, 204). The sounds are digitized by an A/D converter 104 and may be further processed by a sound processor 106 (FIG. 1A block 206) before being stored as a sound file 109 (FIG. 1A blocks 208, 210). Any kind of sound can be captured in this way-birds singing, waterfalls, jet planes, police sirens, wind blowing through grass, human singers, voices, crowd noise, etc. In some cases, instead of or in addition to capturing naturally occurring sounds, synthesizers can be used to create sounds such as sound effects. The resulting collection or library of sound files 109 can be stored (FIG. 1A block 208) and used to create and present one or more sound objects in a virtual 3D soundscape. Often, a library of such sounds are used when creating content. Often, the library defines or uses monophonic sounds for each object, which are then manipulated as described below to provide spatial effects.

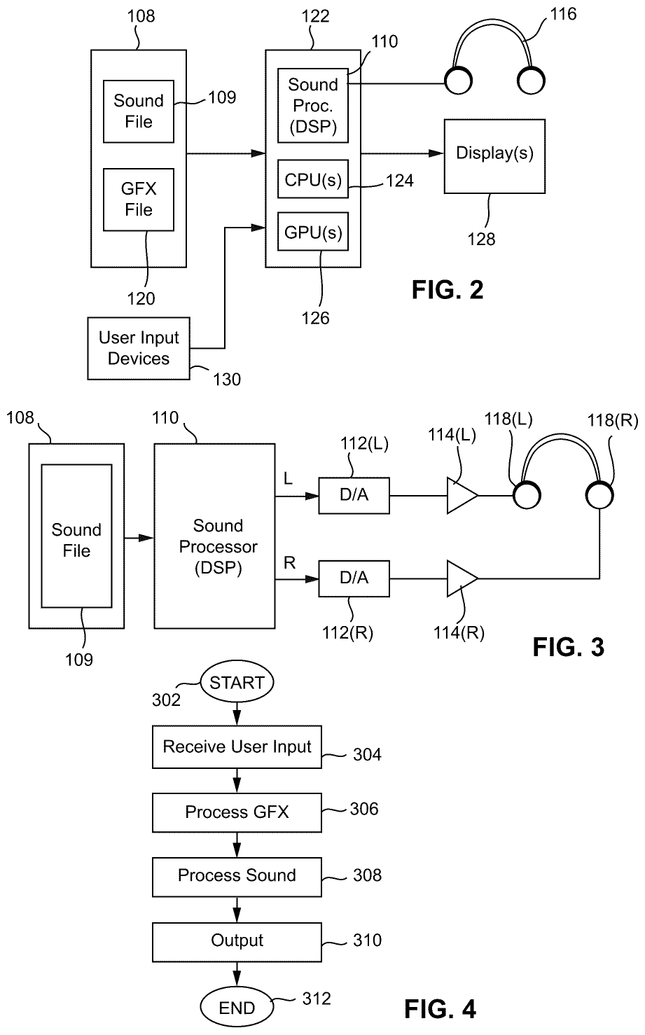

FIG. 2 shows an example non-limiting sound spatializing system including visual as well as audio capabilities. In the example shown, a non-transient storage device 108 stores sound files 109 and graphics files 120. A processing system 122 including a sound processor 110, a CPU 124, and a graphics processing unit 126 processes the stored information in response to inputs from user input devices 130 to provide binaural 3D audio via stereo headphones 116 and 3D graphics via display 128. Display 128 can be any kind of display such as a television, computer monitor, a handheld display (e.g., provided on a portable device such as a tablet, mobile phone, portable gaming system, etc.), goggles, eye glasses, etc. Similarly, headphones provide an advantage of offering full control over separate sound channels that reach each of the listener's left and right ears, but in other applications the sound can be reproduced via loudspeakers (e.g., stereo, surround-sound, etc.) or other transducers in some embodiments. Such a system can be used for real time interactive playback of sounds, or for recording sounds for later playback (e.g., via podcasting or broadcasting), or both. In such cases, the virtual and relative positions of the sound objects and the listener may be fixed or variable. For example, in a video game or virtual reality scenario, the listener may change the listener's own position in the soundscape and may also be able to control the positions of certain sound objects in the soundscape (in some embodiments, the listener position corresponds to a viewpoint used for 3D graphics generation providing a first person or third person “virtual camera” position, see e.g., U.S. Pat. No. 5,754,660). Meanwhile, the processing system may move or control the position of other sound objects in the soundscape autonomously (“bot” control). In a multiplayer scenario, one listener may be able to control the position of some sound objects, and another listener may be able to control the position of other sound objects. In such movement scenarios, the sound object positions are continually changing relative to the positions of the listener's left and right ears. However, example embodiments include but are not limited to moving objects. For example, sound generating objects can change position, distance and/or direction relative to a listener position without being perceived or controlled to “move” (e.g., use of a common sound generating object to provide multiple instances such as a number of songbirds in a tree or a number of thunderclaps from different parts of the sky).

FIG. 3 shows an example non-limiting more detailed block diagram of a 3D spatial sound reproduction system. In the example shown, sound processor 110 generates left and right outputs that it provides to respective digital to analog converters 112(L), 112(R). The two resulting analog channels are amplified by analog amplifiers 114(L), 114(R), and provided to the respective left and right speakers 118(L), 118(R) of headphones 116. The left and right speakers 118(L), 118(R) of headphones 116 vibrate to produce sound waves which propagate through the air and through conduction. These sound waves have timings, amplitudes and frequencies that are controlled by the sound processor 110. The sound waves impinge upon the listener's respective left and right eardrums or tympanic membranes. The eardrums vibrate in response to the produced sound waves, the vibration of the eardrums corresponding in frequencies, timings and amplitudes specified by the sound processor 110. The human brain and nervous system detect the vibrations of the eardrums and enable the listener to perceive the sound, using the neural networks of the brain to perceive direction and distance and thus the apparent spatial relationship between the virtual sound object and the listener's head, based on the frequencies, amplitudes and timings of the vibrations as specified by the sound processor 110.

FIG. 4 shows an example non-limiting system flowchart of operations performed by processing system 122 under control of instructions stored in storage 108. In the example shown, processing system 122 receives user input (blocks 302, 304), processes graphics data (block 306), processes sound data (block 308), and generates outputs to headphones 116 and display 128 (block 310, 312). In one embodiment, this program controlled flow is performed periodically such as once every video frame (e.g., every 1/60^{th} or 1/30^{th} of a second, for example). Meanwhile, sound processor 110 may process sound data (block 308) many times per video frame processed by graphics processor 126. In one embodiment, an application programming interface (API) is provided that permits the CPU 124 to (a) (re)write relative distance, position and/or direction parameters (e.g., one set of parameters for each sound generating object) into a memory accessible by a digital signal, audio or sound processor 110 that performs sound data (block 308), and (b) call the digital signal, audio or sound processor 110 to perform sound processing on the next blocks or “frames” of audio data associated with sounds produced by a sound generating object(s) that the CPU 124 deposits and/or refers to in main or other shared memory accessible by both the CPU 124 and the sound processor 110. The digital signal, audio or sound processor 110 may thus perform a number of sound processing operations each video frame for each of a number of localized sound generating objects to produce a multiplicity of audio output streams that it then mixes or combines together and with other non- or differently processed audio streams (e.g., music playback, character voice playback, non-localized sound effects such as explosions, wind sounds, etc.) to provide a composite sound output to the headphones that includes both localized 3D sound components and non-localized (e.g., conventional monophonic or stereophonic) sound components.

### HRTF-Based Spatialization

In one example, the sound processor 110 uses a pair of HRTF filters to capture the frequency responses that characterize how the left and right ears receive sound from a position in 3D space. Processing system 122 can apply different HRTF filters for each sound object to left and right sound channels for application to the respective left and right channels of headphones 116. The responses capture important perceptual cues such as Interaural Time Differences (ITDs), Interaural Level Differences (ILDs), and spectral deviations that help the human auditory system localize sounds as discussed above.

In many embodiments using multiple sound objects and/or moving sound objects, the filters used for filtering sound objects will vary depending on the location of the sound object(s). For example, the filter applied for a first sound object at (x₁, y₁, z₁) will be different than a filter applied to a second sound object at (x₂, y₂, z₂). Similarly, if a sound object moves from position (x₁, y₁, z₁) to position (x₂, y₂, z₂), the filter applied at the beginning of travel will be different than the filter applied at the end of travel. Furthermore, if sound is produced from the object when it is moving between those two positions, different corresponding filters should be applied to appropriately model the HRTF for sound objects at such intermediate positions. Thus, in the case of moving sound objects, the HRTF filtering information may change over time. Similarly, the virtual location of the listener in the 3D soundscape can change relative to the sound objects, or positions of both the listener and the sound objects can be moving (e.g., in a simulation game in which the listener is moving through the forest and animals or enemies are following the listener or otherwise changing position in response to the listener's position or for other reasons). Often, a set of HRTFs will be provided at predefined locations relative to the listener, and interpolation is used to model sound objects that are located between such predefined locations. However, as will be explained below, such interpolation can cause artifacts that reduce realism.

### Example Architecture

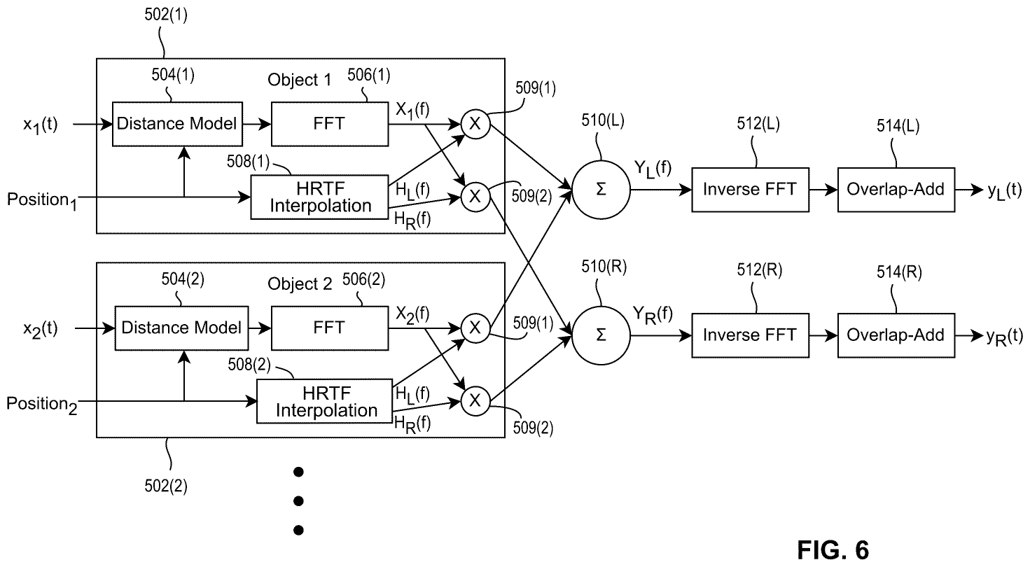

FIG. 6 is a high-level block diagram of an object-based spatializer architecture. A majority of the processing is performed in the frequency-domain, including efficient FFT-based convolution, in order to keep processing costs as low as possible.

### Per-Object Processing

The first stage of the architecture includes a processing loop 502 over each available audio object. Thus, there may be M processing loops 502(1), . . . , 502(M) for M processing objects (for example, one processing loop for each sound object). Each processing loop 502 processes the sound information (e.g., audio signal x(t)) for a corresponding object based on the position of the sound object (e.g., in xyz three dimensional space). Both of these inputs can change over time. Each processing loop 502 processes an associated sound object independently of the processing other processing loops are performing for their respective sound objects. The architecture is extensible, e.g., by adding an additional processing loop block 502 for each additional sound object. In one embodiment, the processing loops 502 are implemented by a DSP performing software instructions, but other implementations could use hardware or a combination of hardware and software.

The per-object processing stage applies a distance model 504, transforms to the frequency-domain using an FFT 506, and applies a pair of digital HRTF FIR filters based on the unique position of each object (because the FFT 506 converts the signals to the frequency domain, applying the digital filters is a simple multiplication indicated by the “X” circles 509 in FIG. 6) (multiplying in the frequency domain is the equivalent of performing convolutions in the time domain, and it is often more efficient to perform multiplications with typical hardware than to perform convolutions).

In one embodiment, all processed objects are summed into internal mix buses Y_{L}(f) and Y_{R}(f) 510(L), 510(R). These mix buses 510(L), 510(R) accumulate all of the filtered signals for the left ear and the right ear respectively. In FIG. 6, the summation of all filtered objects to binaural stereo channels is performed in the frequency-domain. Internal mix buses Y_{L}(f) and Y_{R}(f) 510 accumulate all of the filtered objects:

$${Y}_{L} ( f ) = {\sum }_{i = 1}^{M} {X}_{i} ( f ) {H}_{i , L} ( f )$$

$${Y}_{R} ( f ) = {\sum }_{i = 1}^{M} {X}_{i} ( f ) {H}_{i , R} ( f )$$

where M is the number of audio objects.

### Inverse FFT and Overlap-Add

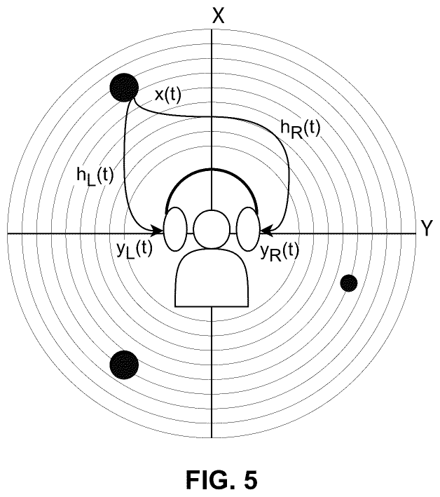

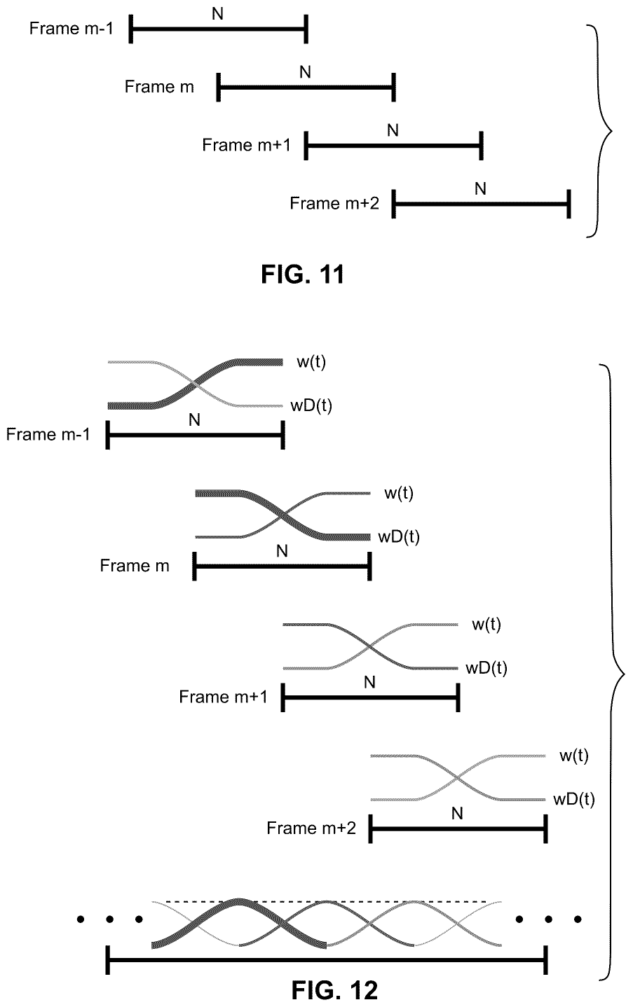

These summed signals are converted back to the time domain by inverse FFT blocks 512(L), 512(R) and overlap-add processes 514(L), 514(R) provide an efficient way to implement convolution of very long signals (see e.g., Oppenheim, et al. Digital signal processing (Prentice-Hall 1975), ISBN 0-13-214635-5; and Hayes, et al. Digital Signal Processing. Schaum's Outline Series (McGraw Hill 1999), ISBN 0-07-027389-8. The output signals y_{L}(t), y_{R}(t) (see FIG. 5) may then be converted to analog, amplified, and applied to audio transducers at the listeners ears. As FIG. 6 shows, an inverse FFT 512 is applied to each of the internal mix buses Y_{L}(f) and Y_{R}(f). The forward FFTs for each object were zero-padded by a factor of 2 resulting in a FFT length of N. Valid convolution can be achieved via the common overlap-add technique with 50% overlapping windows as FIG. 11 shows, resulting in the final output channels y_{L}(t) and y_{R}(t).

### Distance Model 504

Each object is attenuated using a distance model 504 that calculates attenuation based on the relative distance between the audio object and the listener. The distance model 504 thus attenuates the audio signal x(t) of the sound object based on how far away the sound object is from the listener. Distance model attenuation is applied in the time-domain and includes ramping from frame-to-frame to avoid discontinuities. The distance model can be configured to use linear and/or logarithmic attenuation curves or any other suitable distance attenuation function. Generally speaking, the distance model 504 will apply a higher attenuation of a sound x(t) when the sound is travelling a further distance from the object to the listener. For example attenuation rates may be affected by the media through which the sound is travelling (e.g., air, water, deep forest, rainscapes, etc.).

### FFT 506

In one embodiment, each attenuated audio object is converted to the frequency-domain via a FFT 506. Converting into the frequency domain leads to a more optimized filtering implementation in most embodiments. Each FFT 506 is zero-padded by a factor of 2 in order to prevent circular convolution and accommodate an FFT-based overlap-add implementation.

### HRTF Interpolation 508

For a convincing and immersive experience, it is helpful to achieve a smooth and high-quality sound from any position in 3D space. It is common that digital HRTF filters are defined for pre-defined directions that have been captured in the HRTF database. Such a database may thus provide a lookup table for HRTF parameters for each of a number of xyz locations in the soundscape coordinate system (recall that distance is taken care of in one embodiment with the distance function). When the desired direction for a given object does not perfectly align with a pre-defined direction (i.e., vector between a sound object location and the listener location in the soundscape coordinate system) in the HRTF database, then interpolation between HRTF filters can increase realism.

### HRTF Bilinear Interpolation

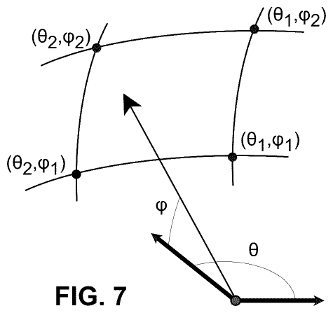

The HRTF interpolation is performed twice, using different calculations for the left ear and the right ear. FIG. 7 shows an example of a region of soundscape space (here represented in polar or spherical coordinates) where filters are defined at the four corners of the area (region) and the location of the sound object and/or direction of the sound is defined within the area/region. In FIG. 7, the azimuth represents the horizontal dimension on the sphere, and the elevation represents the vertical dimension on the sphere. One possibility is to simply take the nearest neighbor—i.e., use the filter defined at the corner of the area that is nearest to the location of the sound object. This is very efficient as it requires no computation. However, a problem with this approach is that it creates perceivably discontinuous filter functions. If the sound object is moving within the soundscape, the sound characteristics will be heard to “jump” from one set of filter parameters to another, creating perceivable artifacts.

A better technique for interpolating HRTFs on a sphere is to use a non-zero order interpolation approach. For example, bilinear interpolation interpolates between the four filters defined at the corners of the region based on distance for each dimension (azimuth and elevation) separately.

Let the desired direction for an object be defined in spherical coordinates by azimuth angle θ and elevation angle φ. Assume the desired direction points into the interpolation region defined by the four corner points (θ₁, φ₁), (θ₁, φ₂), (θ₂, φ₁), and (θ₂, φ₂) with corresponding HRTF filters H_{θ}_{₁}_{,φ}_{₁} (f), H_{θ}_{₁}_{,φ}_{₂} (f), H_{θ}_{₂}_{,φ}_{₁} (f), and H_{θ}_{₂}_{,φ}_{₂} (f). Assume θ₁<θ₂ and θ₁<θ₂ and φ₁≤θ≤θ₂ and φ₁≤φ≤φ₂. FIG. 7 illustrates the scenario.

The interpolation determines coefficients for each of the two dimensions (azimuth and elevation) and uses the coefficients as weights for the interpolation calculation. Let α_{θ} and α_{φ} be linear interpolation coefficients calculated separately in each dimension as:

$${α}_{θ} = \frac{θ - {θ}_{1}}{{θ}_{2} - {θ}_{1}}$$

$${α}_{φ} = \frac{φ - {φ}_{1}}{{φ}_{2} - {φ}_{1}}$$

The resulting bilinearly interpolated HRTF filters are:

$${H}_{L} ( f ) = ( 1 - {α}_{θ} ) ( 1 - {α}_{ϕ} ) {H}_{{θ}_{1} , {φ}_{1} , L} ( f ) + ( 1 - {α}_{θ} ) {α}_{φ} {H}_{{θ}_{1} , {φ}_{2} , L} ( f ) + {α}_{θ} ( 1 - {α}_{φ} ) {H}_{{θ}_{2} , {φ}_{1} , L} ( f ) + {α}_{θ} {α}_{φ} {H}_{{θ}_{2} , {φ}_{2} , L} ( f )$$

$${H}_{R} ( f ) = ( 1 - {α}_{θ} ) ( 1 - {α}_{ϕ} ) {H}_{{θ}_{1} , {φ}_{1} , R} ( f ) + ( 1 - {α}_{θ} ) {α}_{φ} {H}_{{θ}_{1} , {φ}_{2} , R} ( f ) + {α}_{θ} ( 1 - {α}_{φ} ) {H}_{{θ}_{2} , {φ}_{1} , R} ( f ) + {α}_{θ} {α}_{φ} {H}_{{θ}_{2} , {φ}_{2} , R} ( f )$$

The quality of such calculation results depends on resolution of the filter database. For example, if many filter points are defined in the azimuth dimension, the resulting interpolated values will have high resolution in the azimuth dimension. But suppose the filter database defines fewer points in the elevation dimension. The resulting interpolation values will accordingly have worse resolution in the elevation dimension, which may cause perceivable artifacts based on time delays between adjacent HRTF filters (see below).

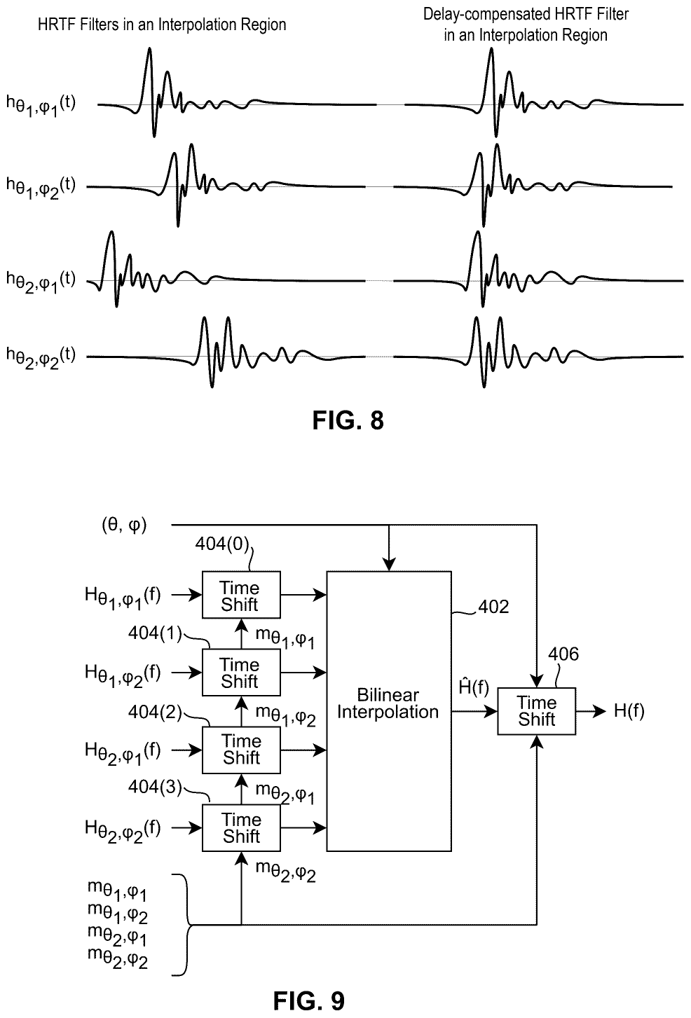

The bilinear interpolation technique described above nevertheless can cause a problem. ITDs are one of the critical perceptual cues captured and reproduced by HRTF filters, thus time delays between filters are commonly observed. Summing time delayed signals can be problematic, causing artifacts such as comb-filtering and cancellations. If the time delay between adjacent HRTF filters is large, the quality of interpolation between those filters will be significantly degraded. The left-hand side of FIG. 8 shows such example time delays between the four filters defined at the respective four corners of a bilinear region. Because of their different timing, the values of the four filters shown when combined through interpolation will result in a “smeared” waveform having components that can interfere with one another constructively or destructively in dependence on frequency. This creates undesirable frequency-dependent audible artifacts that reduces the fidelity and realism of the system. For example, the perceivable comb-filtering effects can be heard to vary or modulate the amplitude up and down for different frequencies in the signal as the sound object position moves between filter locations in FIG. 7.

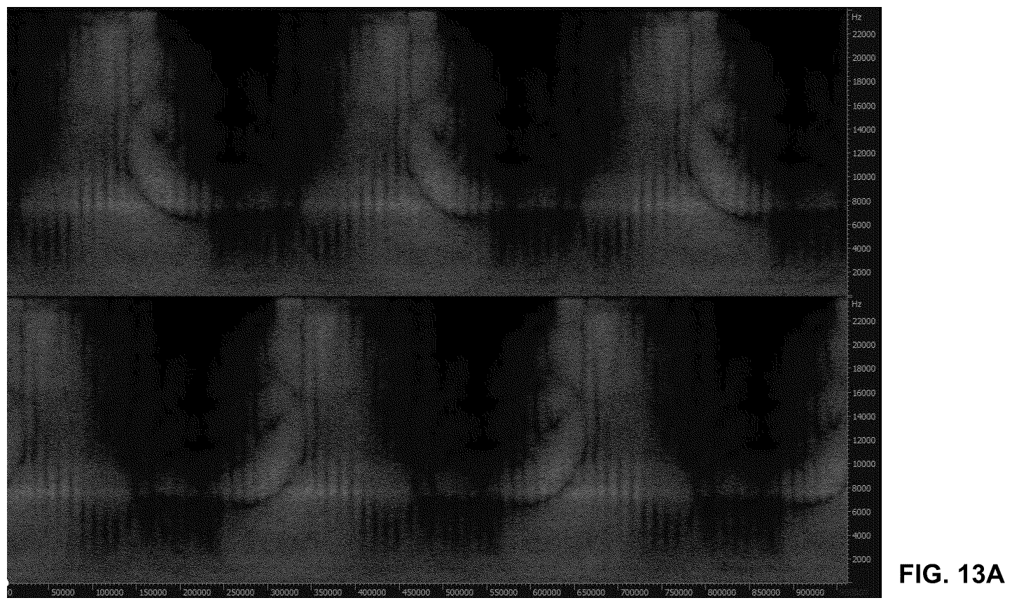

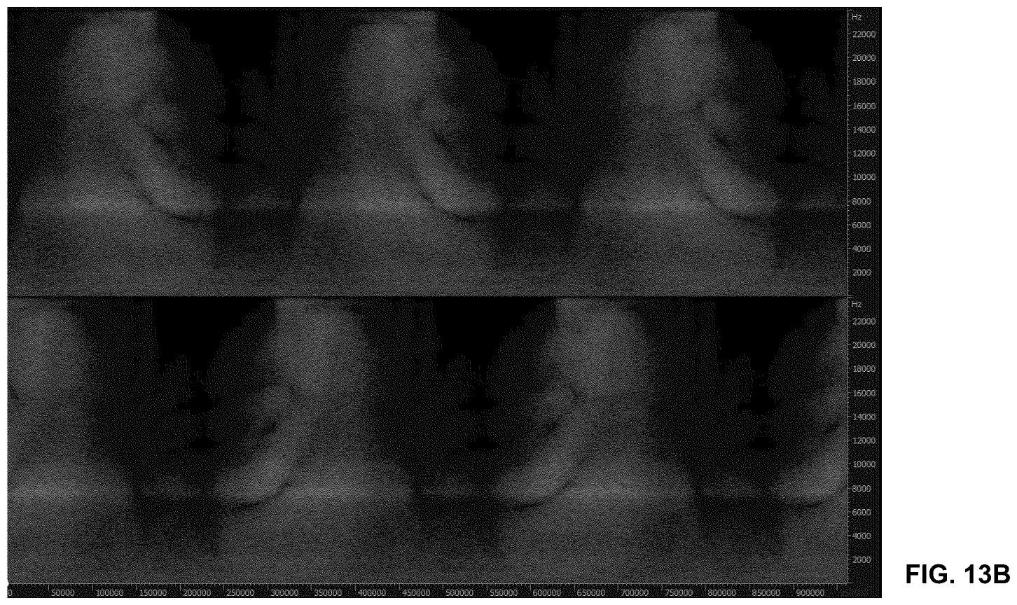

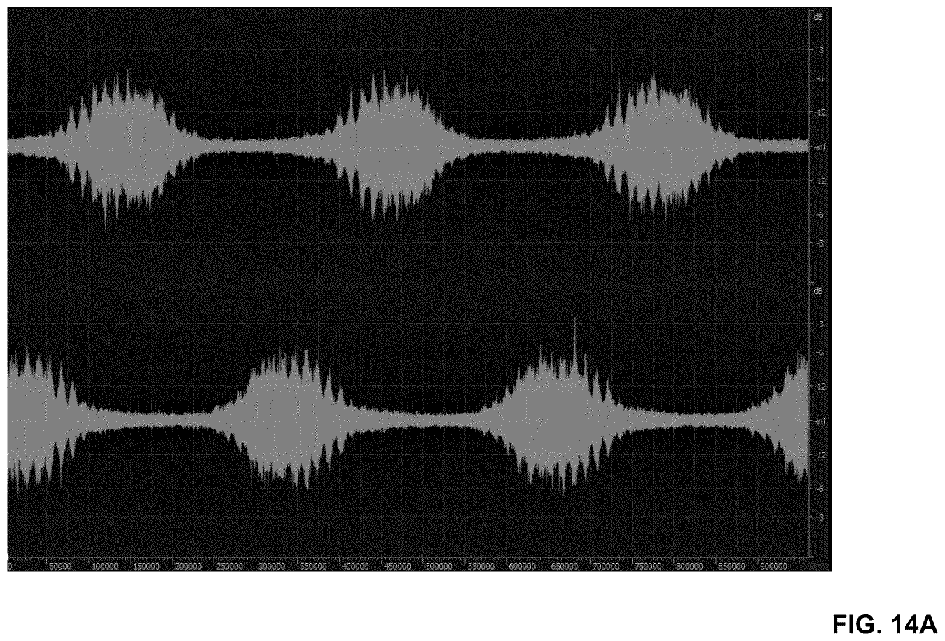

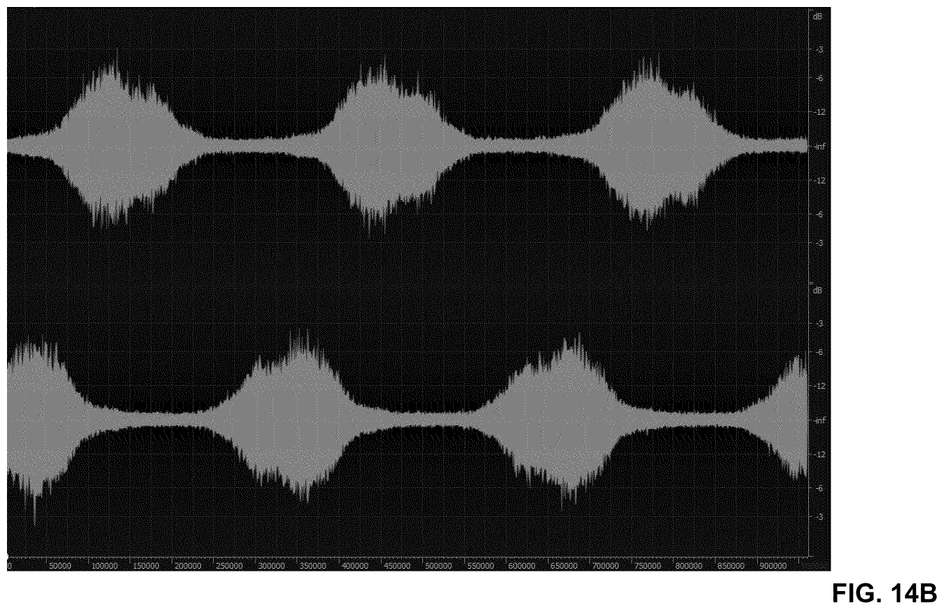

FIG. 14A shows such comb filtering effects in the time domain signal waveform, and FIG. 13A shows such comb filtering effects in the frequency domain spectrogram. These diagrams show audible modulation artifacts as the sound object moves from a position that is perfectly aligned with a filter location to a position that is (e.g., equidistant) between plural filter locations. Note the striping effects in the FIG. 13A spectrogram, and the corresponding peaks in the FIG. 14A time domain signal. Significant artifacts can thus be heard and seen with standard bilinear interpolation, emphasized by the relatively low 15 degree elevation angular resolution of the HRTF database in one example.

### a Better Way: Delay-Compensated Bilinear Interpolation

To address the problem of interpolating between time delayed HRTF filters, a new technique has been developed that is referred to as delay-compensated bilinear interpolation. The idea behind delay-compensated bilinear interpolation is to time-align the HRTF filters prior to interpolation such that summation artifacts are largely avoided, and then time-shift the interpolated result back to a desired temporal position. In other words, even though the HRTF filtering is designed to provide precise amounts of time delays to create spatial effects that differ from one filter position to another, one example implementation makes the time delays “all the same” for the four filters being interpolated, performs the interpolation, and then after interpolation occurs, further time-shifts the result to restore the timing information that was removed for interpolation.

An illustration of the desired time-alignment between HRTF filters is shown in FIG. 8. In particular, the left-hand side of FIG. 8 depicts original HRTF filter as stored in the HRTF database, and the right-hand side of FIG. 8 depicts the same filters after selective time-shifts have been applied to delay-compensate the HRTF filters in an interpolation region.

Time-shifts can be efficiently realized in the frequency-domain by multiplying HRTF filters with appropriate complex exponentials. For example,

$$H ( k ) {e}^{- \frac{i 2 π}{N} k m}$$

will apply a time-shift of m samples to the filter H(k), where N is the FFT length. Note that the general frequency index f has been replaced with the discrete frequency bin index k. Also note that the time-shift m can be a fractional sample amount.

FIG. 9 is a block diagram of an example delay-compensated bilinear interpolation technique. The technique applies appropriate time-shifts 404 to each of the four HRTF filters, then applies standard bilinear interpolation 402, then applies a post-interpolation time-shift 406. Note that the pre-interpolation time-shifts 404 are independent of the desired direction (θ, φ) within the interpolation region, while the bilinear interpolation 402 and post-interpolation time-shift 406 are dependent on (θ, φ). In some embodiments it may not be necessary to time-shift all four filters—for example one of the filters could remain temporally static and the three (or some other number of) other filters could be time-shifted relative to the temporally static filter. In other embodiments, all four (or other number of) HRTF filters may be time-shifted as shown in FIG. 9.

Delay-compensated bilinearly interpolated filters can be calculated as follows (the bilinear interpolation calculation is the same as in the previous example except that multiplication with a complex exponential sequence is added to every filter):

$$( k ) = ( 1 - {α}_{θ} ) ( 1 - {α}_{φ} ) {H}_{{θ}_{1} , {φ}_{1} , L} ( k ) {e}^{- \frac{i 2 π}{N} k {m}_{{θ}_{1} , {φ}_{1} , L}} + ( 1 - {α}_{θ} ) {α}_{φ} {H}_{{θ}_{1} , {φ}_{2} , L} ( k ) {e}^{- \frac{i 2 π}{N} k {m}_{{θ}_{1} , {φ}_{2} , L}} + {α}_{θ} ( 1 - {α}_{φ} ) {H}_{{θ}_{2} , {φ}_{1} , L} ( k ) {e}^{- \frac{i 2 π}{N} k {m}_{{θ}_{2} , {φ}_{1} , L}} + {α}_{θ} {α}_{φ} {H}_{{θ}_{2} , {φ}_{2} , L} ( k ) {e}^{- \frac{i 2 π}{N} k {m}_{{θ}_{2} , {φ}_{2} , L}}$$

$$( k ) = ( 1 - {α}_{θ} ) ( 1 - {α}_{φ} ) {H}_{{θ}_{1} , {φ}_{1} , R} ( k ) {e}^{- \frac{i 2 π}{N} k {m}_{{θ}_{1} , {φ}_{1} , R}} + ( 1 - {α}_{θ} ) {α}_{φ} {H}_{{θ}_{1} , {φ}_{2} , R} ( k ) {e}^{- \frac{i 2 π}{N} k {m}_{{θ}_{1} , {φ}_{2} , R}} + {α}_{θ} ( 1 - {α}_{φ} ) {H}_{{θ}_{2} , {φ}_{1} , R} ( k ) {e}^{- \frac{i 2 π}{N} k {m}_{{θ}_{2} , {φ}_{1} , R}} + {α}_{θ} {α}_{φ} {H}_{{θ}_{2} , {φ}_{2} , R} ( k ) {e}^{- \frac{i 2 π}{N} k {m}_{{θ}_{2} , {φ}_{2} , R}}$$

The complex exponential term mathematically defines the time shift, with a different time shift being applied to each of the four weighted filter terms. One embodiment calculates such complex exponential sequences in real time. Another embodiment stores precalculated complex exponential sequences in an indexed lookup table and accesses (reads) the precalculated complex exponential sequences or values indicative or derived therefrom from the table.

### Efficient Time-Shift for Delay-Compensated Bilinear Interpolation

Performing time-shifts for delay-compensated bilinear interpolation requires multiplying HRTF filters by complex exponential sequences

$${e}^{- \frac{i 2 π}{N} k m} ,$$

where m is the desired fractional time-shift amount. Calculating complex exponential sequences during run-time can be expensive, while storing pre-calculated tables would require significant additional memory requirements. Another option could be to use fast approximations instead of calling more expensive standard library functions.

The solution used in the current implementation is to exploit the recurrence relation of cosine and sine functions. The recurrence relation for a cosine or sine sequence can be written as

$$x [ n ] = 2 cos ( a ) x [ n - 1 ] - x [ n - 2 ]$$

where a represents the frequency of the sequence. Thus, to generate our desired complex exponential sequence

$$s [ k ] = {e}^{- \frac{i 2 π}{N} k m} ,$$

the following equation can be used

$$s [ k ] = 2 cos ( - \frac{2 π}{N} m ) Re ( s [ k - 1 ] ) - Re ( s [ k - 2 ] ) + i ( 2 cos ( - \frac{2 π}{N} m ) Im ( s [ k - 1 ] ) - Im ( s [ k - 2 ] ) )$$

with initial conditions

$$s [ 0 ] = 1$$

$$s [ 1 ] = 2 cos ( - \frac{2 π}{N} m ) + i 2 sin ( - \frac{2 π}{N} m )$$

Since the term cos

$$( - \frac{2 π}{N} m )$$

is constant, it can be pre-calculated once and all remaining values in the sequence can be calculated with just a few multiplies and additions per value (ignoring initial conditions).

### Determination of Time-Shifts

Delay-compensated bilinear interpolation 402 applies time-shifts to HRTF filters in order to achieve time-alignment prior to interpolation. The question then arises what time-shift values should be used to provide the desired alignment. In one embodiment, suitable time-shifts m_{θ}_{ᵢ}_{,φ}_{ⱼ} can be pre-calculated for each interpolation region using offline or online analysis. In other embodiments, the time shifts can be determined dynamically in real time. The analysis performed for one example current implementation uses so-called fractional cross-correlation analysis. This fractional cross-correlation technique is similar to standard cross-correlation, but includes fractional-sample lags. The fractional lag with the maximum cross-correlation is used to derive time-shifts that can provide suitable time-alignment. A look-up table of pre-calculated time-shifts m_{θ}_{ᵢ}_{,φ}_{ⱼ} for each interpolation region may be included in the implementation and used during runtime for each interpolation calculation. Such table can be stored in firmware or other non-volatile memory and accessed on demand. Other implementations can use combinatorial or other logic to generate appropriate values.

With appropriately chosen values for all m_{θ}_{ᵢ}_{,φ}_{ⱼ} (see below), time delays between HRTF filters can be compensated and all HRTF filters can be effectively time-aligned prior to interpolation. See the right-hand side of FIG. 8. However, it is desirable for the resulting time delays of the interpolated filters to transition smoothly across the interpolation region and approach the unmodified filter responses when the desired direction is perfectly aligned with an interpolation corner point (θᵢ, φⱼ). Thus, the interpolated filters can be time-shifted again by an interpolated amount based on the amounts of the original time shifts m_{θ}_{₁}_{,φ}_{₁}, m_{θ}_{₁}_{,φ}_{₂}, m_{θ}_{₂}_{,φ}_{₁}, m_{θ}_{₂}_{,φ}_{₂}.

$${H}_{L} ( k ) = ( k ) {e}^{- \frac{i 2 π}{N} k {m}_{L}}$$

$${H}_{R} ( k ) = ( k ) {e}^{- \frac{i 2 π}{N} k {m}_{R}}$$

$$where$$

$${m}_{L} = ( 1 - {α}_{θ} ) ( 1 - {α}_{φ} ) ( - {m}_{{θ}_{1} , {φ}_{1} , L} ) + ( 1 - {α}_{θ} ) {α}_{φ} ( - {m}_{{θ}_{1} , {φ}_{1} , L} ) + {α}_{θ} ( 1 - {α}_{φ} ) ( - {m}_{{θ}_{2} , {φ}_{1} , L} ) + {α}_{θ} {α}_{φ} ( - {m}_{{θ}_{2} , {φ}_{2} , L} )$$

$${m}_{R} = ( 1 - {α}_{θ} ) ( 1 - {α}_{φ} ) ( - {m}_{{θ}_{1} , {φ}_{1} , R} ) + ( 1 - {α}_{θ} ) {α}_{φ} ( - {m}_{{θ}_{1} , {φ}_{1} , R} ) + {α}_{θ} ( 1 - {α}_{φ} ) ( - {m}_{{θ}_{2} , {φ}_{1} , R} ) + {α}_{θ} {α}_{φ} ( - {m}_{{θ}_{2} , {φ}_{2} , R} )$$

This post-interpolation time-shift 406 is in the opposite direction as the original time-shifts 404 applied to HRTF filters. This allows achievement of an unmodified response when the desired direction is perfectly spatially aligned with an interpolation corner point. The additional time shift 406 thus restores the timing to an unmodified state to prevent timing discontinuities when moving away from nearly exact alignment with a particular filter.

An overall result of the delay-compensated bilinear interpolation technique is that filters can be effectively time-aligned during interpolation to help avoid summation artifacts, while smoothly transitioning time delays over the interpolation region and achieving unmodified responses at the extreme interpolation corner points.

### Effectiveness of Delay-Compensated Bilinear Interpolation

An object that rotates around a listener's head in the frontal plane has been observed as a good demonstration of the effectiveness of the delay-compensated bilinear interpolation technique. FIGS. 13A, 13B, 14A, 14B show example results of a white noise object rotating around a listener's head in the frontal plane when using both standard bilinear interpolation and delay-compensated bilinear interpolation techniques. FIGS. 13B, 14B show example results using delay-compensated bilinear interpolation with significantly smoother or less “striped” signals that reduce or eliminate the comb filtering effects described above. Artifacts are thus substantially avoided when using the delay-compensated bilinear interpolation.

Architecture with Cross-Fade

Time-varying HRTF FIR filters of the type discussed above are thus parameterized with a parameter(s) that represents relative position and/or distance and/or direction between a sound generating object and a listener. In other words, when the parameter(s) that represents relative position and/or distance and/or direction between a sound generating object and a listener changes (e.g., due to change of position of the sound generating object, the listener or both), the filter characteristics of the time-varying HRTF filters change. Such change in filter characteristics is known to cause processing artifacts if not properly handled. See e.g., Keyrouz et al., “A New HRTF Interpolation Approach for Fast Synthesis of Dynamic Environmental Interaction”, JAES Volume 56 Issue 1/2 pp. 28-35; January 2008, Permalink: http://www.aes.org/e-lib/browse.cfm?elib=14373; Keyrouz et al., “A Rational HRTF Interpolation Approach for Fast Synthesis of Moving Sound”, 2006 IEEE 12th Digital Signal Processing Workshop & 4th IEEE Signal Processing Education Workshop, 24-27 Sep. 2006 DOI: 10.1109/DSPWS.2006.265411;

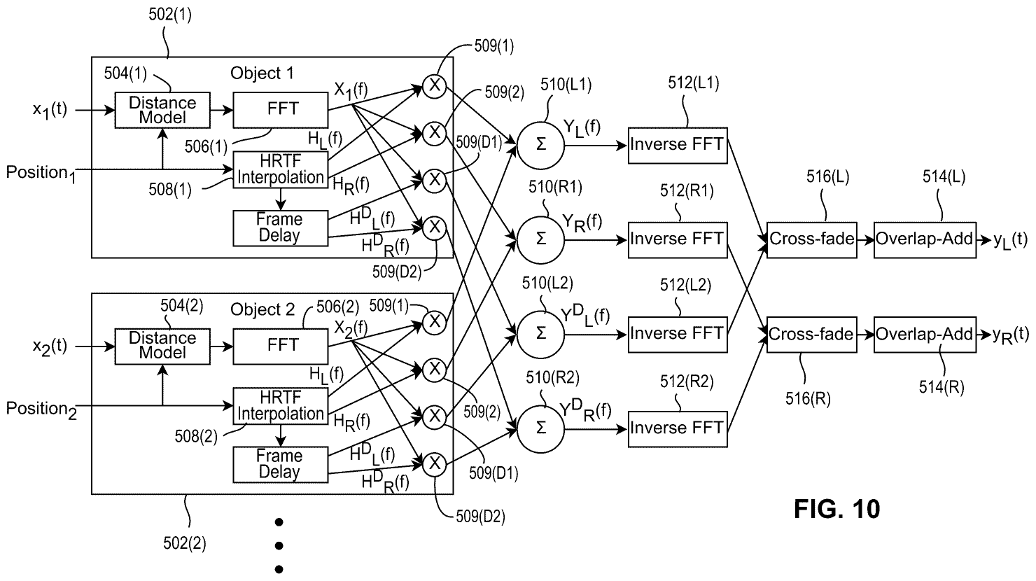

To mitigate artifacts from time-varying FIR filters, an example embodiment provides a modified architecture that utilizes cross-fading between filter results as shown in the FIG. 10 block diagram. In one embodiment, all of the processing blocks are the same as described in previous sections, however the architecture is modified to produce two sets of binaural stereo channels for each frame. However, in other embodiments, the two binaural stereo signals could be produced in any desired manner (e.g., not necessarily using the FIG. 9 time-shift bilinear interpolation architecture) and cross-fading as described below can be applied to provide smooth transitions from one HRTF filter to the next. In other words, the FIG. 10 cross-faders 516 solve a different discontinuity problem than the one solved by the FIG. 9 arrangement, namely, to mitigate discontinuities obtained by convoluting the results of two very different HRTF filter transformations based on the sound object (or the listener, or both) changing position rapidly from one frame to the next. This is an independent problem from the one addressed using time shifts described above, and one technique does not necessarily rely on the other and each technique could be used in respective implementations without the other. Nevertheless, the two techniques can be advantageously used together in a common implementation to avoid both types of discontinuities and associated perceivable artifacts.

### Frame Delay

The FIG. 10 cross-fade architecture includes a frame delay for the HRTF filters. This results in four HRTF filters per object: H_{L}(f) and H_{R}(f) that are selected based on the current object position, and H_{L}^{D}(f) and H_{R}^{D}(f) that are the delayed filters from a previous frame based on a previous object position. In one embodiment, the previous frame may be the immediately preceding frame. In other embodiments, the previous frame may be a previous frame other than the immediately preceding frame.

All four HRTF filters are used to filter the current sound signal produced in the current frame (i.e., in one embodiment, this is not a case in which the filtering results of the previous frame can be stored and reused-rather, in such embodiment, the current sound signal for the current frame is filtered using two left-side HRTF filters and two right-side HRTF filters, with one pair of left-side/right-side HRTF filters being selected or determined based on the current position of the sound object and/or current direction between the sound object and the listener, and the other pair of left-side/right-side HRTF filters being the same filters used in a previous frame time). Another way of looking at it: In a given frame time, the HRTF filters or parameterized filter settings selected for that frame time will be reused in a next or successive frame time to mitigate artifacts caused by changing the HRFT filters from the given frame time to the next or successive frame time. In the example shown, such arrangement is extended across all sound objects including their HRTF filter interpolations, HRTF filtering operations, multi-object signal summation/mixing, and inverse FFT from the frequency domain into the time domain.

Adding frame delayed filters results in identical HRTF filters being applied for two consecutive frames, where the overlap-add regions for those outputs are guaranteed to be artifact-free. This architecture provides suitable overlapping frames (see FIG. 11) that can be cross-faded together to provide smooth transitions. In this context, the term “frame” may comprise or mean a portion of an audio signal stream that includes at least one audio sample, such as a portion comprised of N audio samples. For example, there can be a plurality of audio “frames” associated with a 1/60^{th} or 1/30^{th} of a second duration video frame, each audio frame comprising a number of audio samples to be processed. As explained above, in example embodiment, the system does not store and reuse previous filtered outputs or results, but instead applies the parameterized filtering operation of a previous filtering operation (e.g., based on a previous and now changed relative position between a sound generating object and a listener) to new incoming or current audio data. However, in other embodiments the system could use both previous filtering operation results and previous filtering operation parameters to develop current or new audio processing outputs. Thus, applicant does not intend to disclaim the use of previously generated filter results for various purposes such as known by those skilled in the art.

### Cross-Fade 516

Each cross-fader 516 (which operates in the time domain after an associated inverse FFT block) accepts two filtered signals ŷ(t) and [symbol] (t). A rising cross-fade window w(t) is applied to the signal y(t), while a falling cross-fade window w^{D}(t) is applied to the signal [symbol] (t). In one embodiment, the cross-fader 516 may comprise an audio mixing function that increases the gain of a first input while decreasing the gain of a second input. A simple example of a cross-fader is a left-right stereo “balance” control, which increases the amplitude of a left channel stereo signal while decreasing the amplitude of a right channel stereo signal. In certain embodiments, the gains of the cross-fader are designed to sum to unity (i.e., amplitude-preserving), while in other embodiments the square of the gains are designed to sum to unity (i.e., energy-preserving). In the past, such cross-fader functionality was sometimes provided in manual form as a knob or slider of a “mixing board” to “segue” between two different audio inputs, e.g., so that the end of one song from one turntable, tape, or disk player blended in seamlessly with the beginning of the next song from another turntable, tape, or disk player. In certain embodiments, the cross-fader is an automatic control operated by a processor under software control, which provides cross-fading between two different HRTF filter operations across an entire set of sound objects.

In one embodiment, the cross-fader 516 comprises dual gain controls (e.g., multipliers) and a mixer (summer) controlled by the processor, the dual gain controls increasing the gain of one input by a certain amount and simultaneously decreasing the gain of another input by said certain amount. In one example embodiment, the cross-fader 516 operates on a single stereo channel (e.g., one cross-fader for the left channel, another cross-fader for the right channel) and mixes variable amounts of two inputs into that channel. The gain functions of the respective inputs need not be linear—for example the amount by which the cross-fader increases the gain of one input need not match the amount which the cross-fader decreases the gain of another input. In one embodiment, the gain functions of the two gain elements G₁, G₂ can be G₁₌₀, G₂=x at one setting used at the beginning of (or an early portion of) a frame, and G₁=y, G₂₌₀ at a second setting used at the end of (or a later portion of) the frame, and can provide intermediate mixing values between those two time instants such that some amount of the G₁ signal and some amount of the G₂ signal are mixed together during the frame.

In one embodiment, the output of each cross-fader 516 is thus at the beginning (or a first or early portion) of the frame, fully the result of the frame-delayed filtering, and is thus at the end of (or a second or later portion of) the frame, fully the result of the current(non-frame delayed) filtering. In this way, because one interpolation block produces the result of the previous frame's filtering value while another interpolation block produces the result of the current frame's filtering value, there is no discontinuity at the beginning or the end of frame times even though in between these two end points, the cross-fader 516 produces a mixture of those two values, with the mixture starting out as entirely and then mostly the result of frame-delayed filtering and ending as mostly and then entirely the result of non-frame delayed (current) filtering. This is illustrated in FIG. 12 with the “Red” (thick solid), “Blue” (dashed) and “Green” (thin solid) traces. Since the signal [symbol] (t) results from an HRTF filter that was previously applied in the prior frame, the resulting overlap-add region is guaranteed to be artifact-free(there will be no discontinuities even if the filtering functions are different from one another from frame to frame due to fast moving objects) and provides suitable cross-fading with adjacent frames.

The windows w(n) and w^{D}(n) (using discrete time index n) of length N are defined as

$$w ( n ) = \{ \begin{matrix}0 , & if n \leq \frac{N}{4} \\ {sin}^{2} ( π \frac{n - \frac{N}{4} + 0.5}{N} ) , & if \frac{N}{4} < n \leq \frac{3 N}{4} \\ 1 , & if n > \frac{3 N}{4}\end{matrix}$$

$${w}^{D} ( n ) = \{ \begin{matrix}1 , & if n \leq \frac{N}{4} \\ {cos}^{2} ( π \frac{n - \frac{N}{4} + 0.5}{N} ) , & if \frac{N}{4} < n \leq \frac{3 N}{4} \\ 0 , & if n > \frac{3 N}{4}\end{matrix}$$

In one embodiment, such cross-fading operations as described above are performed for each audio frame. In another embodiment, such cross-fading operations are selectively performed only or primarily when audio artifacts are likely to arise, e.g., when a sound object changes position relative to a listening position to change the filtering parameters such as when a sound generating object and/or the listener changes position including but not limited to by moving between positions.

### Example Implementation Details

In one example, the sample rate of the described system may be 24 kHz or 48 KHz or 60 kHz or 99 kHz or any other rate, the frame size may be 128 samples or 256 samples or 512 samples or 1024 samples or any suitable size, and the FFT/IFFT length may be 128 or 256 or 512 or 1024 or any other suitable length and may include zero-padding if the FFT/IFFT length is longer than the frame size. In one example, each sound object may call one forward FFT and a total of 4 inverse FFTs are used for a total of M+4 FFT calls where M is the number of sound objects. This is relatively efficient and allows for a large number of sound objects using standard DSPs of the type many common platforms are equipped with.

### Additional Enhancement Features

### HRTF Personalization

### Head Size and ITD Cues

HRTFs are known to vary significantly from person-to-person. ITDs are one of the most important localization cues and are largely dependent on head size and shape. Ensuring accurate ITD cues can substantially improve spatialization quality for some listeners. Adjusting ITDs could be performed in the current architecture of the object-based spatializer. In one embodiment, ITD adjustments can be realized by multiplying frequency domain HRTF filters by complex exponential sequences. Optimal ITD adjustments could be derived from head size estimates or an interactive GUI. A camera-based head size estimation technology could be used. Sampling by placing microphones in a given listener's left and right ears can be used to modify or customize the HRTF for that listener.

### Head-Tracking

Head-tracking can be used to enhance the realism of virtual sound objects. Gyroscopes, accelerometers, cameras or some other sensors might be used. See for example U.S. Pat. No. 10,449,444. In virtual reality systems that track a listener's head position and orientation (posture) using MARG or other technology, head tracking information can be used to increase the accuracy of the HRTF filter modelling.

### Crosstalk Cancellation

While binaural stereo audio is intended for playback over headphones, crosstalk cancellation is a technique that can allow for binaural audio to playback over stereo speakers. A crosstalk cancellation algorithm can be used in combination with binaural spatialization techniques to create a compelling experience for stereo speaker playback.

### Use of Head Related Transfer Function

In certain exemplary embodiments, head-related transfer functions are used, thereby simulating 3D audio effects to generate sounds to be output from the sound output apparatus. It should be noted that sounds may be generated based on a function for assuming and calculating sounds that come from the sound objects to the left ear and the right ear of the listener at a predetermined listening position. Alternatively, sounds may be generated using a function other than the head-related transfer function, thereby providing a sense of localization of sounds to the listener listening to the sounds. For example, 3D audio effects may be simulated using another method for obtaining effects similar to those of the binaural method, such as a holophonics method or an otophonics method. Further, in the 3D audio effect technology using the head-related transfer function in the above exemplary embodiments, the sound pressure levels are controlled in accordance with frequencies until the sounds reach the eardrums from the sound objects, and the sound pressure levels are controlled also based on the locations (e.g., the azimuth orientations) where the sound objects are placed. Alternatively, sounds may be generated using either type of control. That is, sounds to be output from the sound output apparatus may be generated using only a function for controlling the sound pressure levels in accordance with frequencies until the sounds reach the eardrums from the sound objects, or sounds to be output from the sound output apparatus may be generated using only a function for controlling the sound pressure levels also based on the locations (e.g., the azimuth orientations) where the sound objects are placed. Yet alternatively, sounds to be output from the sound output apparatus may be generated using, as well as these functions, only a function for controlling the sound pressure levels using at least one of the difference in sound volume, the difference in transfer time, the change in the phase, the change in the reverberation, and the like corresponding to the locations (e.g., the azimuth orientations) where the sound objects are placed. Yet alternatively, as an example where a function other than the head-related transfer function is used, 3D audio effects may be simulated using a function for changing the sound pressure levels in accordance with the distances from the positions where the sound objects are placed to the listener. Yet alternatively, 3D audio effects may be simulated using a function for changing the sound pressure levels in accordance with at least one of the atmospheric pressure, the humidity, the temperature, and the like in real space where the listener is operating an information processing apparatus.

In addition, if the binaural method is used, sounds to be output from the sound output apparatus may be generated using peripheral sounds recorded through microphones built into a dummy head representing the head of a listener, or microphones attached to the inside of the ears of a person. In this case, the states of sounds reaching the eardrums of the listener are recorded using structures similar to those of the skull and the auditory organs of the listener, or the skull and the auditory organs per se, whereby it is possible to similarly provide a sense of localization of sounds to the listener listening to the sounds.

In addition, the sound output apparatus may not be headphones or earphones for outputting sounds directly to the ears of the listener, and may be stationary loudspeakers for outputting sounds to real space. For example, if stationary loudspeakers, monitors, or the like, are used as the sound output apparatus, a plurality of such output devices can be placed in front of and/or around the listener, and sounds can be output from the respective devices. As a first example, if a pair of loudspeakers (so-called two-channel loudspeakers) is placed in front of and on the left and right of the listener, sounds generated by a general stereo method can be output from the loudspeakers. As a second example, if five loudspeakers (so-called five-channel loudspeakers or “surround sound”) are placed in front and back of and on the left and right of the listener (as well as in the center), stereo sounds generated by a surround method can be output from the loudspeakers. As a third example, if multiple loudspeakers (e.g., 22.2 multi-channel loudspeakers) are placed in front and back of, on the left and right of, and above and below the listener, stereo sounds using a multi-channel acoustic system can be output from the loudspeakers. As a fourth example, sounds generated by the above binaural method can be output from the loudspeakers using binaural loudspeakers. In any of the examples, sounds can be localized in front and back of, on the left and right of, and/or above and below the listener. This makes it possible to shift the localization position of the vibrations using the localization position of the sounds. See U.S. Pat. No. 10,796,540 incorporated herein by reference.

While the description herein relies on certain operations (e.g., fractional time shifting) in the frequency domain, it would be possible to perform the same or similar operations in the time domain. And while the description herein relies on certain operations (e.g., cross-fading) in the time domain, it would be possible to perform the same or similar operations in the frequency domain. Similarly, implementations herein are DSP based in software, but some or all of the operations could be formed in hardware or in a combination of hardware and software.

### Crosstalk Cancellation

The intended playback of binaural stereo audio is for each audio channel to be reproduced independently at each corresponding ear of a listener. Specifically, the left channel delivered to a listener's left ear only and the right channel to the right ear only such as through headphones, earbuds or the like.

A binaural stereo signal is commonly generated via binaural recording or HRTF-based spatialization processing, where localization cues are inherently captured as ILD, ITD, and spectral filter differences between the stereo channels. With proper binaural reproduction, a listener may experience a convincing virtualization of a real-world soundfield or soundscape, where accurate sound pressure levels are recreated at each of the listener's ears. Headphones provide a high quality sound listening experience because they are able to deliver sounds selectively to one ear or the other ear of the listener, and also isolate the two ears from one another.

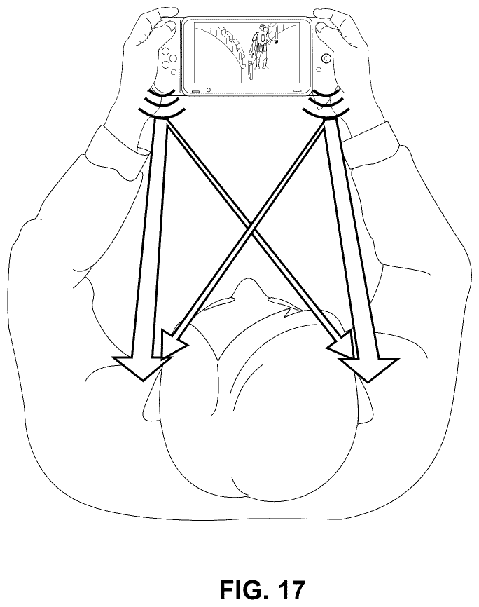

While headphones are commonly and successfully used for playback of binaural stereo audio, there are situations where playback via loudspeakers is desired. See for example FIG. 17 showing a handheld video game console that includes a left loudspeaker and a right loudspeaker. Instead of using headphones or earbuds, the user can use these loudspeakers to listen to the sound generated by the handheld video game console. However, a major problem arises when trying to playback binaural audio over stereo loudspeakers; as shown in the Figure, the sound coming from the left loudspeaker reaches both of the listener's ears, not just the left ear. Similarly for the right loudspeaker, the sound coming from the right loudspeaker reaches both of the listener's ears, not just the right ear.

Sound that travels from the left loudspeaker to the right ear and sound that travels from the right loudspeaker to the left ear are each known as “crosstalk.” In a headphone playback context, it is reasonable to assume that the left channel sound will go only to the left ear, and the right channel sound will go only to the right ear. In contrast, in the free space playback context some of the left channel sound will now go to the right ear, and some of the right channel sound will now go to the left ear. Such unintended crosstalk can significantly degrade the intended binaural listening experience.

Crosstalk cancellation is a well known technique that attempts to mitigate the crosstalk problem for binaural reproduction over loudspeakers by acoustically cancelling the unwanted crosstalk at each of the listener's ears. As one example, an out of phase, attenuated, and delayed version of the sound that “leaks” from the left channel to the right ear can be supplied to cancel out the leaking or misdirected sound. Similarly, an out of phase, attenuated, and delayed version of the sound that “leaks” from the right channel to the left ear can be supplied to cancel out the leaking or misdirected sound. Such cancellation techniques are reasonably effective in reducing crosstalk.

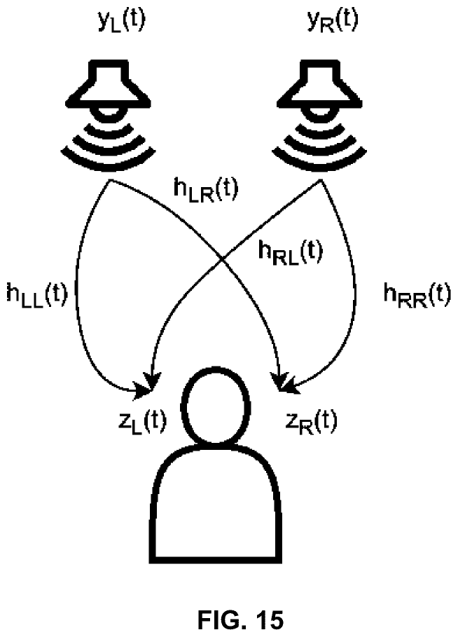

FIGS. 15, 16 and 17 illustrate scenarios of binaural reproduction over stereo loudspeakers.

Let y_{L}(t) and y_{R}(t) be the left and right channels of a binaural signal, and h_{LL}(t), h_{RR}(t), h_{LR}(t), and h_{RL}(t) be the impulse responses of the corresponding ipsilateral and contralateral paths from the stereo loudspeakers to each of the listener's ears. The signals arriving at the listener's ears z_{L}(t) and Σ_{R}(t) are a combination of the ipsilateral and contralateral paths and can be described as

$${z}_{L} ( t ) = {y}_{L} ( t ) * {h}_{L L} ( t ) + {y}_{R} ( t ) * {h}_{R L} ( t )$$

$${z}_{R} ( t ) = {y}_{R} ( t ) * {h}_{R R} ( t ) + {y}_{L} ( t ) * {h}_{L R} ( t )$$

These equations can be equivalently expressed in the frequency-domain as

$${Z}_{L} ( f ) = {Y}_{L} ( f ) {H}_{L L} ( f ) + {Y}_{R} ( f ) {H}_{R L} ( f )$$

$${Z}_{R} ( f ) = {Y}_{R} ( f ) {H}_{R R} ( f ) + {Y}_{L} ( f ) {H}_{L R} ( f )$$

If the goal is to accurately reproduce the original binaural channels at each of the listener's ears, then the presence of crosstalk paths impair this goal. To improve binaural reproduction, let us consider incorporating knowledge about the crosstalk paths and loudspeaker transfer functions by generating modified channels Y_{L}′(f) and Y_{R}′(f) such that the resulting signals arriving at the listener's ears are equal to the original binaural channels themselves:

$${Y}_{L} ( f ) = {Y}_{L}^{′} ( f ) {H}_{L L} ( f ) + {Y}_{R}^{′} ( f ) {H}_{R L} ( f )$$

$${Y}_{R} ( f ) = {Y}_{R}^{′} ( f ) {H}_{R R} ( f ) + {Y}_{L}^{′} ( f ) {H}_{L R} ( f )$$

Solving these equations for the modified channels leads to

$${Y}_{L}^{′} ( f ) = \frac{{Y}_{L} ( f ) {H}_{R R} ( f ) - {Y}_{R} ( f ) {H}_{R L} ( f )}{{H}_{L L} ( f ) {H}_{R R} ( f ) - {H}_{L R} ( f ) {H}_{R L} ( f )}$$

$${Y}_{R}^{′} ( f ) = \frac{{Y}_{R} ( f ) {H}_{L L} ( f ) - {Y}_{L} ( f ) {H}_{L R} ( f )}{{H}_{L L} ( f ) {H}_{R R} ( f ) - {H}_{L R} ( f ) {H}_{R L} ( f )}$$

Thus, with a priori knowledge of characteristics (i.e., ipsilateral and contralateral transfer functions) of the stereo loudspeakers used for reproduction, it is possible to achieve reasonable binaural perception over stereo loudspeakers via some relatively simple signal modifications.

### Subjective Evaluation: Spectral Coloration and Object Instability

The previous formulation for binaural reproduction over loudspeakers was implemented and tested. During subjective evaluation, listeners reported a reasonably good ability to localize the spatial position of objects, however significant coloration of object audio and some instability of object movements were reported.

The amount and spectral shape of coloration was noted as being dependent on the position of a virtual object in the soundscape. In particular, coloration was reported as most significant for objects on the sides of a listener (e.g., object positions near (+90°, 0°)). Coloration was also reported as being most significant for mid to high frequencies, but not as noticeable for low frequencies. Additionally, unstable object movement was noted for object positions near the median plane (e.g., positions with azimuth angle near) 0°, where relatively small lateral movements off of the median plane would result in exaggerated localization with larger perceived lateral movements than expected.

The perceived artifacts of coloration and instability may be explained by acknowledging that some assumptions used in the crosstalk cancellation formulation may not be completely valid. While the previous formulation for crosstalk cancellation relies on linear system theory and implies that “perfect” reproduction at a listener's ears can be modeled and achieved, in practice, there are a number of non-idealities that may impair reproduction accuracy.

A first non-ideality that degrades or can degrade performance is imperfect characterization of the ipsilateral and contralateral transfer functions for a particular listener. Measuring highly accurate transfer functions for every unique listener is challenging, if not impossible, for many use-cases. Since individual measurement and personalized transfer functions are not feasible in many use-cases, it is common to use predetermined generalized transfer functions that are reasonably accurate for as broad a population as possible. Ideally, each listener's ipsilateral and contralateral transfer functions would be perfectly characterized, accurately capturing a listener's unique anatomy (e.g., head shape and size), position and alignment relative to the loudspeakers, relevant listening environment features (e.g., nearby reflections), etc. However, use of imperfectly characterized transfer functions may result in crosstalk cancellation inaccuracy and unpredictable artifacts for a particular listener in a particular environment.

A second non-ideality that degrades or can degrade performance is the non-ideal nature of real-world acoustics. While acoustic signals are commonly thought of as linear sound waves that can be modeled as a linear time-invariant (LTI) system, in reality, the interaction of acoustic waves in real-world environments is complex and not necessarily linear. For example, this phenomenon leads to the common use of nonlinear panning laws when trying to intensity pan sounds between pairs of loudspeakers. Sound designers commonly use panning laws to pan a mono signal to the center of a stereo image where the pan law setting defines the attenuation of each channel. Sound designers typically use pan laws of −3 dB or −4.5 dB to achieve approximately equal loudness for center-panned sounds. However, a pan law of −6 dB would be expected if real-world acoustics were perfectly linear. Acknowledging that real-world acoustics are not perfectly linear is another explanation for crosstalk cancellation inaccuracy and unpredictable artifacts for a listener.

For a high-quality user experience of binaural reproduction over loudspeakers, a solution to mitigate coloration and instability artifacts is desirable. Since coloration and instability artifacts were perceived as being dependent on the position of an object, a per-object processing approach has been developed to reduce artifacts based on the unique position of each object.

### Per-Object Approach

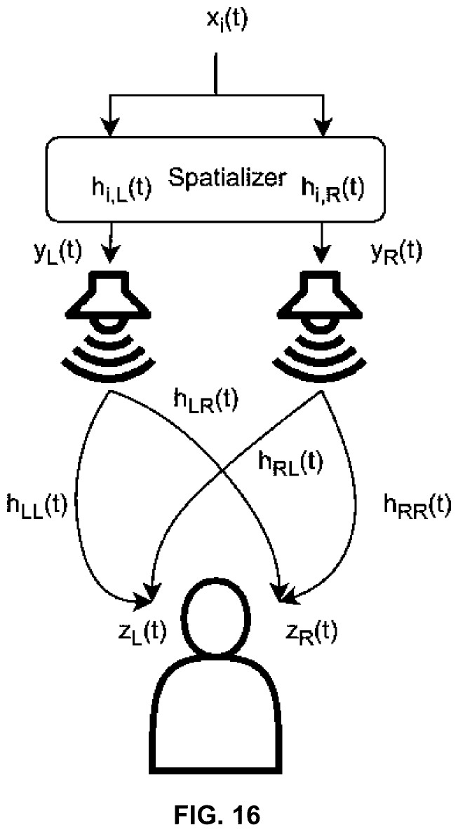

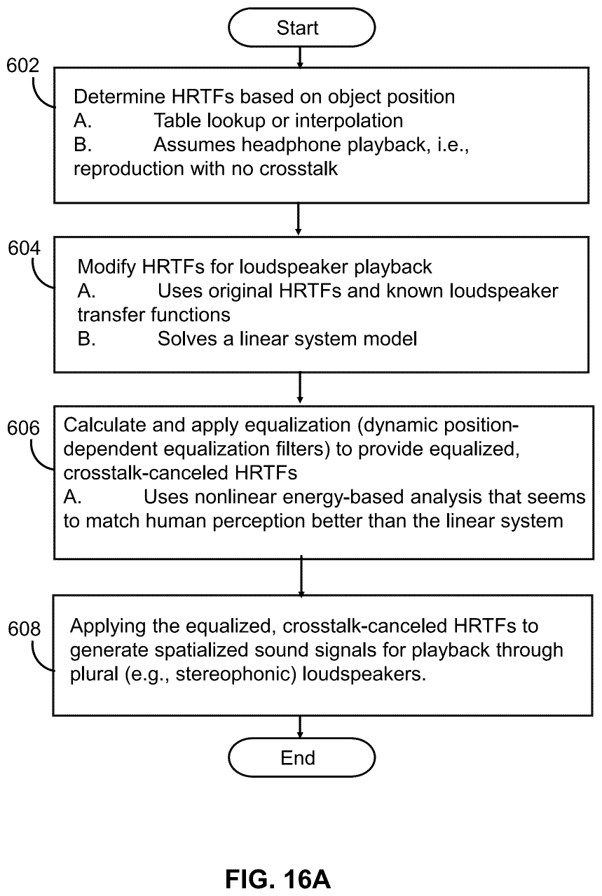

Instead of reproducing a fully pre-rendered binaural signal consisting of unknown and arbitrary content, let us consider the use-case of binaural reproduction over loudspeakers for objects processed by a spatializer algorithm. FIG. 16 illustrates a scenario where a mono audio object xᵢ(t) is convolved with left and right HRTF filters h_{i,L}(t) and h_{i,R}(t) by a spatializer algorithm.

For the above scenario, the signals arriving at the listener's ears for a given object i can be expressed as

$${Z}_{L} ( f ) = {X}_{i} ( f ) [ {H}_{i , L} ( f ) {H}_{L L} ( f ) + {H}_{i , R} ( f ) {H}_{R L} ( f ) ]$$

$${Z}_{R} ( f ) = {X}_{i} ( f ) [ {H}_{i , R} ( f ) {H}_{R R} ( f ) + {H}_{i , L} ( f ) {H}_{L R} ( f ) ]$$

Let H_{i,L}′(f) and H_{i,R}′(f) be modified HRTF filters such that the resulting signals arriving at the listener's ears are equal to the monophonic audio object convolved by the original HRTF filters, i.e., Z_{L}(f)=Xᵢ(f)H_{i,L}(f) and Z_{R}(f)=Xᵢ(f)H_{i,R}(f), similar to headphone listening:

$${X}_{i} ( f ) {H}_{i , L} ( f ) = {X}_{i} ( f ) [ {H}_{i , L}^{′} ( f ) {H}_{L L} ( f ) + {H}_{i , R}^{′} ( f ) {H}_{R L} ( f ) ]$$

$${X}_{i} ( f ) {H}_{i , R} ( f ) = {X}_{i} ( f ) [ {H}_{i , R}^{′} ( f ) {H}_{R R} ( f ) + {H}_{i , L}^{′} ( f ) {H}_{L R} ( f ) ]$$

Solving for the modified HRTF filters leads to

$${H}_{i , L}^{′} ( f ) = \frac{{H}_{i , L} ( f ) {H}_{RR} ( f ) - {H}_{i , R} ( f ) {H}_{RL} ( f )}{{H}_{LL} ( f ) {H}_{RR} - {H}_{LR} ( f ) {H}_{RL} ( f )}$$

$${H}_{i , R}^{′} ( f ) = \frac{{H}_{i , R} ( f ) {H}_{LL} ( f ) - {H}_{i , L} ( f ) {H}_{LR} ( f )}{{H}_{LL} ( f ) {H}_{RR} - {H}_{LR} ( f ) {H}_{RL} ( f )}$$

Thus, calculating and applying modified HRTF filters H_{i,L}′(f) and H_{i,R}′(f) for each object in a spatializer algorithm may provide proper binaural perception over loudspeakers for each object.

Since different perceptible artifacts have been observed depending on an object's position, let us investigate per-object approaches intended to mitigate such artifacts. In the following two subsections, we will describe additional techniques that can be used to further analyze and modify HRTF filters in an attempt to reduce noticeable artifacts.

### Per-Object Stability

In previous sections, perceived object instability was identified as an artifact arising from binaural reproduction over loudspeakers. In particular, for object positions near the median plane, it was reported that small lateral movements may correspond to exaggerated perceived localization. For example, when an object is located directly on the median plane, such as directly in front of a listener at position (0°, 0°), the object may be perceived as being on the median plane. However, when the object moves slightly off of the median plane, such as to position (5°, 0°) or (−5°, 0°), the listener may report exaggerated perceived localization of (15°, 0°) or (−15°, 0°), respectively. Thus, small lateral movements near the median plane may correspond to larger perceived movements than intended.

To add some perceived stability to lateral object movements near the median plane, one example embodiment is to mix crosstalk cancelled HRTFs with the original HRTFs in a position-dependent manner. Specifically, it is noted that for positions near the median plane, the interaural localization cues of ITD and ILD are small, instead relying on pinna spectral filter cues as the dominant localization cues indicating elevation and front-back positioning. Since incorporating crosstalk cancellation into the HRTFs appears to provide excessive lateral perceived localization near the median plane, one example embodiment partially mixes original HRTFs with the crosstalk cancelled HRTFs to lessen the exaggerated crosstalk cancelled cues while preserving the original pinna spectral cues. The crosstalk cancelled and original HRTFs are crossfaded in a position-dependent manner to generate modified crosstalk cancelled HRTFs H_{i,L}″(f) and H_{i,R}″(f) as follows

$${H}_{i , L}^{″} ( f ) = ( 1 - {γ}_{i} ) {H}_{i , L} ( f ) + {γ}_{i} {H}_{i , L}^{′} ( f )$$

$${H}_{i , R}^{″} ( f ) = ( 1 - {γ}_{i} ) {H}_{i , R} ( f ) + {γ}_{i} {H}_{i , R}^{′} ( f )$$

$$where$$

$${γ}_{i} = max ( ϵ , {( abs ( sin ( {θ}_{i} ) cos ( {φ}_{i} ) ) )}^{ρ} )$$

where ∈ is a subjectively tuned parameter between 0 and 1 that controls the maximum amount of original HRTF to mix and ρ is a subjectively tuned parameter that controls a nonlinear relationship between position and amount of original HRTF to mix. Note that the sin(θᵢ)cos(φᵢ) term in the γᵢ equation corresponds to the Cartesian y-coordinate (i.e., lateral coordinate) of the object position. Thus, fully crosstalk cancelled HRTFs will be used for objects on the sides of a listener (i.e., object positions near (±90°, 0°)), while original HRTFs become increasingly weighted as an object approaches the median plane. Values near ∈=0.5 and ρ=2 have been successful in improving object stability during subjective testing.

### Per-Object Equalization

In previous sections, spectral coloration was identified as another significant artifact arising from binaural reproduction over loudspeakers. Specifically, spectral coloration was reported as being position-dependent, where the shape and amount of coloration changes based on the position of an object. Thus, a static position-independent filter is inadequate for mitigating coloration artifacts. To reduce coloration, let us consider calculating and applying dynamic position-dependent equalization filters for each virtual sound generating object in a virtual soundscape. This is possible in example embodiments because the sound generating system has available to it parameters from which the directionalities and lengths of paths between each virtual sound generator and the user's ears can be derived.

For example, in one embodiment, the sound generating system has access to the virtual positions or locations in 3D virtual space of each virtual sound source as well as possibly other information about the sound sources such as size/dimensions and the original and crosstalk cancelled HRTFs calculated for the object. From this position or location information, the sound generator can determine the length and direction of the paths between each virtual sound source and each ear of the user. FIR filters used to provide spatialization can then be parameterized/customized/modified to alter frequency response on a per virtual sound source or object basis in order to avoid or reduce spectral coloration artifacts due to crosstalk cancellation.

Example embodiments model what this might sound like to the user, which can be used to predict what the user will hear with such coloration. A goal may be to have the user hear the same frequency response they would hear if listening in headphones(no crosstalk).

In one embodiment, the sound generating apparatus internally models what a sound generated by a particular object is likely to sound like to a user not using headphones, and compensates the HRTF filters for that sound generated by that object for spectral changes resulting from crosstalk compensation of that particular object. Such equalization is dependent on the location of each sound generating object because the HRTF's being applied to sounds generated by such sound generating objects are location-dependent. The equalization curves applied to different sound generating locations are different because the HRTF filtering function being applied for spatialization is dependent on sound generating location.

Equalization curves are developed from the predictions, in order to equalize out the coloration based on (relative) position of the sound object. Thus, the same or similar equalization can be applied to each sound source object having the same or similar (relative) position, to obtain the same or similar frequency response as the user would hear if or when using headphones. Thus, in some embodiments, the same equalization can be applied to all objects within a certain region of the 3D soundscape, with different equalizations applied to objects within different soundscape regions. The sizes and extents of such areas can be defined as needed to provide desired precision. However, in the disclosure above, a bilinear interpolation provides a unique HRTF for each unique sound generating object location. Thus, in example embodiments, when a sound generating object changes position, the HRTF will change accordingly—and spectral coloration equalization (crosstalk cancellation compensation) will also change accordingly. In one example, the coloration equalization is integrated as part of the HRTF filtering, providing a low overhead solution that uses the same FIR filtering operations to both provide spatial sound effects and to compensate (equalize) those spatial sound effects for crosstalk effects.

Furthermore, in example embodiments, the equalization is independent of the particular sound effects and characteristics (other than location) of the virtual sound generating objects generating those particular sound effects (e.g., music, voice, engine sounds, etc.). Thus, in example embodiments, the equalization process can be applied to any arbitrary game or other sound generating presentation.

### Example Practical Implementation

As previously described, due to real-world non-idealities, there will likely be error between true and modeled sound pressure levels at a listener's ears. This error may be one of the causes of significant coloration (e.g., frequency response changes) observed in practice. As previously described, crosstalk cancelled HRTFs are derived based on modeling sound waves as a linear system. However, there are other common methods of analyzing audio signals based on energy or power models such as methods used in localization theory (e.g., Gerzon's metatheory of localization), spatial audio coding (e.g., parametric stereo coding, directional audio coding, spatial audio scene coding), and ambisonics (e.g., max-re weighted decoders). Since we acknowledge that the linear crosstalk cancellation formulation may contain error, let's consider re-analyzing the derived crosstalk cancelled HRTFs using other nonlinear methods to potentially identify relevant differences and apply further modifications to the HRTFs to reduce perceptible artifacts.

Let E_{HP,i}(f) and E_{LS,i}(f) be total energy level estimates at a listener's ears for a given object i for both headphone (HP) and loudspeaker (LS) reproduction, where headphone reproduction uses original HRTFs H_{i,L}(f) and H_{i,R}(f) and loudspeaker reproduction uses crosstalk cancelled HRTFs H_{i,H}″(f) and H_{i,R}″(f):

$${E}_{HP , i} ( f ) = {\vert {H}_{i , L} ( f ) \vert}^{2} + {\vert {H}_{i , R} ( f ) \vert}^{2}$$

$${E}_{LS , i} ( f ) = {\vert {H}_{i , L}^{″} ( f ) {H}_{L L} ( f ) \vert}^{2} + {\vert {H}_{i , R}^{″} ( f ) {H}_{R R} ( f ) \vert}^{2} + {\vert {H}_{i , L}^{″} ( f ) {H}_{L R} ( f ) \vert}^{2} + {\vert {H}_{i , R}^{″} ( f ) {H}_{R L} ( f ) \vert}^{2}$$

Note that the total energy estimate for headphone reproduction assumes a flat headphone frequency response, while the total energy estimate for loudspeaker reproduction incorporates the ipsilateral and contralateral transfer functions.

Since our goal is to make binaural reproduction over loudspeakers as perceptually similar as possible to binaural reproduction over headphones, differences between the total energy estimates E_{HP,i}(f) and E_{LS,i}(f) may indicate potential coloration. Let σᵢ (f) be an equalization filter that is calculated from the headphone and loudspeaker total energy estimates as

$${σ}_{i} ( f ) = \sqrt{\frac{{E}_{HP , i} ( f )}{{E}_{LS , i} ( f )}}$$

The equalization filter σᵢ(f) is designed to normalize the estimated total energy for loudspeaker reproduction relative to headphone reproduction. If applied to the crosstalk cancelled HRTF filters, this equalization filter will result in the total energy reproduced at the listener's ears for loudspeaker reproduction to be approximately equal to that for headphone reproduction for each frequency band.

Applying the equalization filter σᵢ(f) to the crosstalk cancelled HRTFs H_{i,L}″(f) and H_{i,R}″(f) was implemented and tested. During subjective evaluation, listeners reported a substantial improvement in perceived coloration, particularly in the mid to high frequency regions. However, coloration in the low frequency region was actually reported as worsened. One explanation for why coloration may be subjectively improved or worsened in different frequency regions when applying energy-based equalization may come from the realization that the human auditory system uses different perceptual mechanisms in different frequency regions.

In localization theory (e.g., Gerzon's metatheory of localization, duplex theory), it is widely accepted that different perceptual cues are used differently in different frequency regions. Phase delay cues are primarily relevant for low frequencies (e.g., <800 Hz) where the dimensions of the head are smaller than the half wavelength of sound waves. Level difference cues are primarily relevant for high frequencies (e.g., >1500 Hz) where significant head shadowing effects are observed.

Since the human auditory system is known to use different mechanisms in different frequency regions, we will consider applying the equalization filter differently in different regions. In Gerzon's metatheory, a velocity model is deemed valid for frequencies below ˜700 Hz where signal amplitude gains are used to derive localization, and an energy model is deemed valid for frequencies above ˜1 kHz where signal energy gains are used. Motivated by this, frequency-dependent application of the equalization filter has been implemented and tested. Significant overall improvements in perceived coloration have been observed across the frequency spectrum and for all object positions by creating final modified crosstalk cancelled HRTFs H_{i,L}′″(f) and H_{i,R}′″(f) via the following equations:

$${H}_{i , L}^{′′′} ( f ) = ( 1 - μ ( f ) ) {H}_{i , L}^{″} ( f ) + μ ( f ) {σ}_{i} ( f ) {H}_{i , L}^{″} ( f )$$

$${H}_{i , R}^{′′′} ( f ) = ( 1 - μ ( f ) ) {H}_{i , R}^{″} ( f ) + μ ( f ) {σ}_{i} ( f ) {H}_{i , R}^{″} ( f )$$

$$where$$

$$μ ( f ) = \{ \begin{matrix}0 , & if f \leq {f}_{c , Low} Hz \\ {sin}^{2} ( \frac{f - {f}_{c , Low}}{{f}_{c , High} - {f}_{c , Low}} \frac{π}{2} ) , & if {f}_{c , Low} Hz < f \leq {f}_{c , High} Hz \\ 1 , & if f > {f}_{c , High} Hz\end{matrix}$$

where f_{c,Low} is a low transition band cutoff frequency and f_{c,High} is a high transition band cutoff frequency. From the above equations, we can observe that the final modified crosstalk cancelled HRTFs H_{i,L}′″(f) and H_{i,R}′″(f) will consist of the unequalized crosstalk cancelled HRTFs H_{i,L}″(f) and H_{i,R}″(f) for low frequencies below f_{c,Low}, fully equalized crosstalk cancelled HRTFs σᵢ(f)H_{i,L}″(f) and σᵢ(f)H_{i,R}″(f) for high frequencies above f_{c,High}, and partially equalized crosstalk cancelled HRTFs for mid frequencies between f_{c,Low} and f_{c,High}. Thus, for mid and high frequencies, the final crosstalk cancelled HRTFs end up being equalized by an energy-based nonlinear acoustic model. Transition band values of f_{c,Low}=800 Hz and f_{c,High}=1500 Hz have been successful in improving overall object coloration during subjective testing.

### Example Flowchart

FIG. 16A is an example flowchart that in one embodiment is performed by the system described above to reduce sound “coloration” perceived when reproducing crosstalk cancelled binaural audio via plural loudspeakers. These steps may be performed by for example a sound codec, sound processing integrated circuit, or sound processing circuit in a playback device such as a video game platform, a personal computer, a tablet, a smart phone, or the like. The instructions that encode the steps shown in FIG. 16A may for example be stored in the firmware of a video game platform (e.g., in FLASH ROM), read from the storage device and executed by a sound processor.

The first (1) step (block 602) is to determine HRTFs based on object position as described above. This can be done by for example table lookup or interpolation as described above. Also as described above, this step in one embodiment assumes binaural reproduction, i.e., reproduction with no crosstalk, and uses conventional HRTFs designed/intended for headphone playback.

The second (2) step (block 604) is to modify the HRTFs for loudspeaker playback instead of headphone playback. In one embodiment, this step uses (a) the original HRTFs noted above and (b) known or assumed loudspeaker transfer functions, and solves a linear system model.

The third (3) step (block 606) calculates and applies equalization on a per-object basis to reduce “coloration” (i.e., unwanted frequency-dependentintensity deviations) produced during the plural loudspeaker playback, to provide equalized, crosstalk-canceled HRTFs. This involves applying different amplitude boosts or attenuations to different frequency bands across the frequency spectrum of sound associated with a particular object. In particular, amplitude boosts are applied to increase the amplitude in a frequency band, and amplitude attenuations are applied to reduce the amplitude in a frequency band. The same thing is repeated for each sound frequency spectrum of each object 1-N, where there are N different sound-producing objects.

In one embodiment, this step (block 606) uses nonlinear energy-based analysis in order to determine the amount of boost/attenuation to apply for each frequency band. This nonlinear energy-based analysis seems to match human perception better than the linear system solution in step 2 (block 604), particularly at higher frequencies. Essentially, we re-analyze and modify the results of a linearly-derived solution using nonlinear analysis. Since nonlinear systems are generally difficult to solve, it's not trivial how we could have directly formulated and solved a nonlinear system. And operating per-object is helpful because in nonlinear systems superposition doesn't hold, so we would not achieve the same results by operating on the combined or mixed output of multiple objects.

Example embodiments include a fourth (4) step (block 608) of applying the equalized, crosstalk-canceled HRTFs to generate spatialized sound signals suitable for playback through plural (e.g., stereophonic) loudspeakers. This involves applying the equalized HRTFs associated with a particular object 1 to spatialize the sound that object 1 produces; applying the equalized HRTFs associated with a particular object 2 to spatialize the sound that object 2 produces; . . . , applying the equalized HRTF associated with a particular object N to spatialize the sound that object N produces; mixing together the spatialized multichannel sound of object 1, the spatialized multichannel sound of object 2, . . . the spatialized multichannel sound of object N; amplifying the (e.g., left and right) mixed signals; and applying the (e.g., left and right) mixed signals to respective (e.g., left and right) loudspeakers for playback through the air to a user's left and right ears, respectively. Since the HRTFs for each object were modified to incorporate crosstalk cancellation and minimize coloration, a listener should perceive localized virtual objects with minimal coloration.

### Example Implementation Details

As shown in the FIG. 17 example handheld stereophonic (multi-channel) game device, it is possible to know with a high degree of certainty precisely where the left stereophonic speaker and right stereophonic speaker of the handheld device are located. Additionally, because the form factor of the handheld device is known, it is possible to predict with a reasonable degree of certainty how a user will hold the handheld game device, the path directions and lengths between the left and right loudspeakers and the left and right ears of the user, and the sound radiating characteristics such as directionality of the left and right speakers. Thus, it is possible to predict the location of each of the left stereophonic speaker and the location of the right stereophonic speaker relative to the user's left ear and right ear (i.e., by predicting where the user's head will be relative to the handheld device) as well as other characteristics and factors that affect crosstalk from the left speaker to the user's right ear and from the right speaker to the user's left ear. The example embodiments thus use modeling that takes advantage of the physical constraints imposed by the form factor(s) and limited range of operating modes of a particular set of handheld video game devices. While the techniques herein can work even with arbitrary devices, they are even more effective when used with a uniform device such as one or a small number of different handheld video game devices exhibiting known, uniform geometry and characteristics.

Example Algorithm Parameters

| Parameter | Supported Value |
|---|---|
| Sample Rate | 48 kHz |
| Frame Size | 256 samples/frame |
| FFT/IFFT Length | 512 |
| Maximum Number | User-defined at |
| of Objects | initialization |

All patents, patent applications, and publications cited herein are incorporated by reference for all purposes as if expressly set forth.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method comprising:
determining head-related transfer functions (HRTFs) based on virtual object position;
modifying the determined HRTFs for loudspeaker playback; and
calculating and applying equalization to the modified HRTFs to provide equalized, crosstalk-canceled HRTFs.

2. The method of claim 1 further comprising applying the equalized, crosstalk-canceled HRTFs to generate spatialized sound signals for playback through plural loudspeakers.

3. The method of claim 1 wherein applying equalization comprises applying different amplitude boosts or attenuations to different respective frequency bands.

4. The method of claim 1 wherein sound is generated by plural objects, and calculating and applying includes calculating and applying equalization on a per-object basis.

5. The method of claim 1 wherein determining is based at least in part on table lookup or interpolation, and assumes headphone playback.

6. The method of claim 1 wherein modifying uses a loudspeaker transfer function and solves a linear system model.

7. The method of claim 1 wherein calculating and applying uses a nonlinear analysis which matches human perception better than a linear system model.

8. The method of claim 1 wherein calculating and applying comprises:
associating first position information with a first sound generating virtual object; and
applying first HRTF filtering parameterized by the first position information to filter a first multichannel sound associated with the first sound generating virtual object;
wherein the first HRTF filtering is configured to equalize the first filtered multichannel sound based on the first position information to compensate for spectral coloration of the first filtered multichannel sound caused by crosstalk.

9. The method of claim 8 further comprising:
associating second position information with a second sound generating virtual object; and
applying second HRTF filtering parameterized by the second position information to filter a second multichannel sound associated with the second sound generating virtual object;
wherein the second HRTF filtering is configured to equalize the second filtered multichannel sound based on the second position information to compensate for spectral coloration of the second filtered multichannel sound caused by crosstalk.

10. The method of claim 8 wherein the first position information comprises a Y position coordinate or a path direction or direction of a path from the first sound generating virtual object to a listener or a designation of a region in a virtual soundfield.

11. The method of claim 8 wherein equalizing comprises modifying spatialization provided by the first HRTF filtering.

12. The method of claim 8 further comprising mixing crosstalk-cancelled HRTFs with original HRTFs in a position-dependent manner.

13. The method of claim 1 further comprising moving the object as part of video game play.

14. The method of claim 1 wherein applying comprises bilinearly interpolating based on object position information.

15. A system comprising at least one sound processor configured to perform operations comprising:
determining head-related transfer functions (HRTFs) based on virtual object position;
modifying the determined HRTFs for loudspeaker playback; and
calculating and applying equalization to the modified HRTFs to provide equalized, crosstalk-canceled HRTFs.

16. The system of claim 15 wherein the operations further comprise applying the equalized, crosstalk-canceled HRTFs to generate spatialized sound signals for playback through plural loudspeakers.

17. The system of claim 15 wherein applying equalization comprises applying different amplitude boosts or reductions to different respective frequency bands.

18. The system of claim 15 wherein sound is generated by plural objects, and calculating and applying includes calculating and applying equalization on a per-object basis.

19. The system of claim 15 wherein determining is based at least in part on table lookup or interpolation, and assumes headphone playback.

20. The system of claim 15 wherein modifying applies a loudspeaker transfer function and solves a linear system model.

21. The system of claim 15 wherein calculating and applying uses a nonlinear analysis which matches human perception better than a linear system model.

22. The system of claim 15 wherein calculating and applying comprises:
associating first position information with a first sound generating virtual object; and
applying first HRTF filtering parameterized by the first position information to filter a first multichannel sound associated with the first sound generating virtual object;
wherein the first HRTF filtering is configured to equalize the first filtered multichannel sound based on the first position information to compensate for spectral coloration of the first filtered multichannel sound caused by crosstalk.

23. The system of claim 22 wherein the operations further comprise:
associating second position information with a second sound generating virtual object; and
applying second HRTF filtering parameterized by the second position information to filter a second multichannel sound associated with the second sound generating virtual object;
wherein the second HRTF filtering is configured to equalize the second filtered multichannel sound based on the second position information to compensate for spectral coloration of the second filtered multichannel sound caused by crosstalk.

24. The system of claim 22 wherein the first position information comprises a Y position coordinate or a path direction or direction of a path from the first sound generating virtual object to a listener or a designation of a region in a virtual soundfield.

25. The system of claim 22 wherein equalizing comprises modifying spatialization provided by the first HRTF filtering.

26. The system of claim 22 wherein the operations further comprise mixing crosstalk-cancelled HRTFs with original HRTFs in a position-dependent manner.

27. The system of claim 26 wherein the operations further comprise moving the object as part of video game play.

28. The system of claim 15 wherein applying comprises bilinearly interpolating based on object position information.
